(19) United States
(12) Patent Application Publication
(10) Pub. No.: US 2023/0232833 A1
(43) Pub. Date: Jul. 27, 2023

(54) Synergistic Compositions for the Control of Mosquito-Borne Diseases

(71) Applicant: Universite d'Angers, Angers (FR)

(72) Inventors: Marine EL ADOUZI, Montpellier (FR); Véronique APAIRE-MARCHAIS, Angers (FR); Valérie RAYMOND, Bouchemaine (FR); Bruno LAPIED, Angers (FR)

(73) Assignee: Universite d'Angers, Angers (FR)

(21) Appl. No.: 18/012,095

(22) PCT Filed: Jun. 29, 2021
(86) PCT No.: PCT/EP2021/067833

§ 371 Date: Dec. 21, 2022

(30) Foreign Application Priority Data
Jun. 30, 2020 (EP) 20183036.1

(51) Int. Cl. A01N 51/00; A01P 7/04; A01N 47/42; A01N 37/30

(52) U.S. Cl. CPC A01N 51/00; A01P 7/04; A01N 47/42; A01N 37/30

(57) ABSTRACT

The present invention relates to binary and ternary synergistic combinations and to mosquito insecticides and mosquito larvicides containing such synergistic combinations. The present invention also concerns the use of the mosquito insecticides and mosquito larvicides in the control of mosquito-borne diseases, such as, for example, malaria, dengue, Zika, chikungunya and yellow fever.

### RELATED APPLICATION

The present application claims priority to European Patent Application No. EP 20 183 036.1 filed on Jun. 30, 2020, which is incorporated herein by reference in its entirety.

### BACKGROUND OF THE INVENTION

Mosquito-borne diseases are medical conditions caused by bacteria, viruses or parasites transmitted by mosquitoes. Nearly 700 million people get a mosquito-borne disease each year resulting in over one million deaths (U.S. Centers for Disease Control and Prevention). Mosquitoes are thus considered one of the deadliest creatures on the planet. In 2016, cases of malaria alone reached 216 million resulting in an estimated 445,000 deaths (World Health Organization (WHO)—World Malaria Report 2017). In recent years, the rate of infection has increased dramatically. The worldwide incidence of dengue has raised 30-fold in the past 30 years, and more countries are reporting their first outbreaks of the disease. Having spread to almost every country in the Americas in 2016, the mosquito borne Zika virus was declared a global public health emergency by the WHO and called an “extraordinary event”. Zika, dengue, chikungunya, and yellow fever are all transmitted to humans by a single mosquito species, Aedes aegypti; and more than half of the world's population live in areas where this mosquito species is present. Furthermore, a growing number of scientists are now concerned that global warming will translate into an explosive growth of mosquito-borne diseases worldwide.

In this public health context of emergence/re-emergence of vector-borne diseases, such as malaria, dengue, chikungunya and Zika, health authorities like the WHO are looking for new strategies to reduce the risk of infection. They include limiting contact with mosquitoes that are vectors of these often-severe pathologies, for which there is no vaccine and no treatment, mainly using chemicals in intra- and extra-domiciliary applications and/or treating various textiles, such as clothes and mosquito nets.

Today, as part of the disease vector control, most textiles, such as mosquito nets for example, are impregnated with pyrethroid-type insecticides, which have both an insecticidal and repulsive action. Unfortunately, the emergence of resistances against these insecticides in mosquito populations calls into question their efficacy and therefore their uses. In fact, mosquito resistance, which is defined as an inherited decrease in sensitivity to an insecticide, corresponds to a form of adaptation to a new environment created by the presence of insecticides, according to a natural selection process. In addition to the treatments carried out in the context of disease vector control, mosquitoes are also subjected to the insecticidal pressure resulting from agriculture and domestic uses, thus accelerating the phenomenon and the transmission of genes of resistance in vector populations, resulting in a loss of treatment effectiveness.

Therefore, there still remains, in the art, an ongoing need for new strategies for vector control of mosquito-borne diseases.

### SUMMARY OF THE INVENTION

The present Applicants have uncovered the synergistic effects of a binary combination comprising the two neonicotinoids, thiacloprid and thiamethoxam, and of a ternary combination comprising the repellent IR3535 and the two neonicotinoids, thiacloprid and thiamethoxam. They showed that the synergistic combinations have significant insecticidal activity against mosquitoes, in particular against mosquito larvae. Neonicotinoïd molecules have never been used alone against mosquitoes, and consequently mosquitoes have not developed known resistance against these molecules. This is important because resistant mosquitoes that have never been directly treated with a neonicotinoid type are not resistant to this family of insecticides. The proposed strategy can therefore be used against mosquitoes, and in particular against mosquito larvae, which are currently resistant to conventional insecticides, such as pyrethroids, organophosphates and carbamates, and against which the available means of control are becoming ineffective.

Accordingly, in one aspect, the present invention provides a mosquito insecticide comprising a binary synergistic combination consisting of thiacloprid and thiamethoxam or comprising a ternary synergistic combination consisting of thiacloprid, thiamethoxam and IR3535.

In certain embodiments, the mosquito insecticide is a mosquito adulticide.

In other embodiments, the mosquito insecticide is a mosquito larvicide.

In certain embodiments, in the synergistic binary mixture of thiacloprid and thiamethoxam, the molar ratio between thiacloprid and thiamethoxam is comprised between about 0.01:1 and about 1:0.01, preferably between about 0.1:1 and about 1:0.1.

In certain embodiments, in the synergistic ternary mixture of thiacloprid, thiamethoxam and IR3535, the molar ratio between IR3535 and the mixture of thiacloprid and thiamethoxam is comprised between about 0.005:1 and about 0.1:1, more preferably between about 0.01:1 and about 0.1:1. For example, in the synergistic ternary mixture of thiacloprid, thiamethoxam and IR3535, the molar ratio between thiacloprid and thiamethoxam may be comprised between about 0.01:1 and about 1:0.01, preferably between about 0.1:1 and about 1:0.1.

In certain embodiments, in the mosquito insecticide comprising a binary synergistic combination of thiacloprid and thiamethoxam, the concentration of each of thiacloprid and thiamethoxam is comprised between about 10⁻⁹ M and about 10⁻⁵ M, preferably between about 5·10⁻⁸ M and about 5·10⁻⁶ M.

In certain embodiments, in the mosquito insecticide comprising an in vitro ternary synergistic mixture of thiacloprid, thiamethoxam and IR3535, the concentration of IR3535 is comprised between about 5·10⁻¹² M and about 5·10⁻⁹ M, preferably between about 10⁻¹¹ M and about 5·10⁻¹⁰ M, and the concentration of each of thiacloprid and thiamethoxam is comprised between about 10⁻⁹ M and about 10⁻⁵ M, preferably between about 5·10⁻⁸ M and about 5·10⁻⁶ M.

In certain embodiments, in the mosquito insecticide (in particular larvicide) comprising an in vivo ternary synergistic mixture of thiacloprid, thiamethoxam and IR3535, the concentration of IR3535 is 100 mg/L (4.6·10⁻⁴M), the concentration of thiacloprid is 0.01 mg/L (4·10⁻⁸M), or less, and the concentration of thiamethoxam is 0.02 mg/L (6.9·10⁻⁸M) or less. In such embodiments, the mosquito insecticide is a mosquito larvicide. Preferably, the mosquito larvicide is intended to be used against mosquito larvae that are resistant to conventional insecticides, in particular resistant to pyrethroids.

In certain embodiments, in the mosquito insecticide (in particular larvicide) comprising an in vivo ternary synergistic mixture of thiacloprid, thiamethoxam and IR3535, the concentration of IR3535 is 100 mg/L (4.6·10⁻⁴M), the concentration of thiacloprid is 0.01 mg/L (4·10⁻⁸M) or less, and the concentration of thiamethoxam is 0.01 mg/L (3.4·10⁻⁸M) or less. In such embodiments, the mosquito insecticide is a mosquito larvicide. Preferably, the mosquito larvicide is intended to be used against mosquito larvae that are resistant to conventional insecticides, in particular resistant to organophosphates and carbamates.

In certain embodiments, the mosquito insecticide further comprises at least one additional biologically active agent.

In another aspect, the present invention further relates to the use of a mosquito insecticide disclosed herein to prevent or inhibit infestation of mosquitoes.

In certain embodiments, the mosquitoes are insecticide resistant. For example, the mosquitoes may be resistant to at least one insecticide selected from the group consisting of organophosphate insecticides, carbamate insecticides, and pyrethroid insecticides.

In certain embodiments, the mosquito insecticide is used to control mosquito-borne diseases, wherein the mosquito-borne diseases are transmitted by mosquitoes infected by a pathogen selected from the group consisting of viruses, nematodes, protozoa, and bacteria.

In certain embodiments, the mosquito-borne diseases are transmitted to mammal hosts, in particular human beings.

In certain embodiments, the mosquito-borne diseases are selected from the group consisting of Zika virus infection, Dengue fever infection, Yellow fever, Chikungunya, West Nile virus infection, St. Louis Encephalitis, Dengue and malaria.

In certain embodiments, the mosquitoes belong to a genus selected from the group consisting of the Aedes, Anopheles, Culex, Culiseta and Mansonia genuses. For example, the mosquitoes may belong to a species selected from the group consisting of Aedes aegypti, Aedes albopictus, Aedes australis, Aedes cantator, Aedes cinereus, Aedes polynesiensis, Aedes rusticus, Aedes taeniorhynchus, Aedes vexans, Anopheles species: Anopheles albimanus, Anopheles arabiensis, Anopheles atroparvus, Anopheles baimaii, Anopheles balabacensis, Anopheles barberi, Anopheles bellator, Anopheles cruzii, Anopheles culicifacies, Anopheles darlingi, Anopheles dirus, Anopheles earlei, Anopheles farauti, Anopheles freeborni, Anopheles funestus, Anopheles gambiae, Anopheles introlatus, Anopheles latens, Anopheles leucosphyrus, Anopheles maculatus, Anopheles minimus, Anopheles moucheti, Anopheles nili, Anopheles punctipennis, Anopheles punctulatus, Anopheles pseudopunctipennis, Anopheles quadrimaculatus, Anopheles sergentii, Anopheles sinensis, Anopheles stephensi, Anopheles subpictus, Anopheles sundaicus, Anopheles walkeri, Culex annulirostris, Culex antennatus, Culex jenseni, Culex pipiens, Culex pusillus, Culex quinquefasciatus, Culex rajah, Culex restuans, Culex salinarius, Culex tarsalis, Culex territans, Culex theileri, Culex tritaeniorhynchus, Culiseta incidens, Culiseta impatiens, Culiseta inornata, Culiseta particeps, Mansonia annulifera, Mansonia bonneae, Mansonia dives, Mansonia indiana, Mansonia uniformis.

In certain embodiments, the mosquitoes belong to a species selected from the group consisting of Aedes aegypti, Aedes albopictus, Culex quinquefasciatus, Culex pipiens, Culex tarsalis.

These and other objects, advantages and features of the present invention will become apparent to those of ordinary skill in the art having read the following detailed description of the preferred embodiments.

### BRIEF DESCRIPTION OF THE FIGURES

FIG. 1. Summary diagram of the mechanical dissociation protocol for mosquito heads to obtain isolated neurons maintained in short-term cultures.

FIG. 2. Visualization of the variations in the intracellular calcium concentration within a neuron cell body using the fluorescence calcium technique. The pseudo-colors indicate the level of intracellular calcium: blue for a low intracellular calcium concentration and red for a strong increase in calcium.

FIG. 3. Photographs illustrating the sorting of the larvae of late L3/early L4 stages in batches of 25 (left) and the deposit of the larvae in a beaker containing the substance to be tested (right).

FIG. 4. Comparative histograms illustrating the synergistic action of IR3535 tested at different concentrations on the effect of thiacloprid on neurons isolated from Anopheles gambiae mosquito strains AcerKis (left) and Kis (right). Data are expressed as mean±S.E.M. N represents the number of neurons used from 10 to 20 different experiments. Kruskal-Wallis and Mann-Whitney test, ** p-value<0.01, *** p-value<0.001.

FIG. 5. Comparative histograms illustrating the synergistic action of IR3535 tested at different concentrations on the effect of thiamethoxam on neurons isolated from Anopheles gambiae mosquito strains AcerKis (left) and Kis (right). Data are expressed as mean±S.E.M. N represents the number of neurons used from 5 to 33 different experiments. Kruskal-Wallis and Mann-Whitney test, ** p-value<0.01, *** p-value<0.001.

FIG. 6. Comparative histograms illustrating the synergistic action of IR3535 on the effect of the association thiacloprid/thiamethoxam on neurons isolated from the Anopheles gambiae mosquito strain Kis. Data are expressed as mean±S.E.M. N represents the number of neurons used from 5 to 16 different experiments. Kruskal-Wallis and Mann-Whitney test, * p-value<0.05, ** p-value<0.01.

FIG. 7. Comparative histograms illustrating the synergistic action of IR3535 tested at different concentrations on the thiacloprid effect on the mortality of larvae of Anopheles gambiae strain AcerKis and strain Kis. Data are expressed as mean±S.E.M. N between 1 and 6 replicates of 100 individuals.

FIG. 8. Comparative histograms illustrating the synergistic effect of two neonicotinoids in combination, thiacloprid and thiamethoxam, on the mortality, observed at 24 hours, of larvae of Anopheles gambiae strain AcerKis. Data are expressed as mean±S.E.M. N=2 replicates de 80 individuals.

FIG. 9. Effects of IR3535 used alone on larval mortality of resistant strains AcerKis and KdrKis. Comparative histograms illustrate the action of IR3535 tested at different concentrations on the mortality of Anopheles gambiae larvae at 24 hours and 48 hours in a. the AcerKis strain and b. the KdrKis strain. Mean±S.E.M, N between 2 and 6 replicates of 75 to 100 individuals. No significant difference between the mortality rates at these concentrations was observed (Mann-Whitney; p-value>0.05).

FIG. 10. Effects of thiacloprid and thiamethoxam used alone on the mortality of larvae of AcerKis and KdrKis strains. Concentration-mortality (log-probit) regression curves for thiacloprid (a, c) and thiamethoxam (b, d) on Anopheles gambia larvae of the AcerKis (a, b) and KdrKis (c, d) strains. Four replicates of 100 individuals per strain and per insecticide were used.

FIG. 11. Effects of the binary combination thiacloprid/thiamethoxam on the Anopheles gambia larvae of resistant strains AcerKis and KdrKis at 24 hours. Comparative histograms illustrate the effect of the thiacloprid/thiamethoxam combination on the mortality of Anopheles gambia larvae of resistant strain AcerKis (a) and of resitant strain KdrKis (b). The concentrations of thiacloprid and of thiamethoxam in the combination were 0.02 mg/L and 0.04 mg/L, respectively. Mean±S.E.M, N between 2 and 3 replicates of 80 to 100 individuals.

FIG. 12. Effects of the binary combination thiacloprid/thiamethoxam on the Anopheles gambia larvae of resistant strains AcerKis and KdrKis at 48 hours. Comparative histograms illustrate the effect of the thiacloprid/thiamethoxam combination on the mortality of Anopheles gambia larvae of resistant strain AcerKis (a, b) and of resitant strain KdrKis (c, d). The concentrations of thiacloprid and of thiamethoxam in the binary combinations were 0.01 mg/L and 0.01 mg/L (a, c) and 0.01 mg/L and 0.02 mg/L (b, d), respectively. Mean±S.E.M, N between 3 and 14 replicates of 50 to 100 individuals. Mann-Whitney: * p-value<0.05; ** p-value<0.01; *** p-value<0.001.

FIG. 13. Effects of the ternary combination IR3535/thiacloprid/thiamethoxam on the Anopheles gambia larvae of resistant strains AcerKis and KdrKis. Comparative histograms illustrate the effect of the IR3535/thiacloprid/thiamethoxam combination on the mortality of Anopheles gambia larvae of resistant strain AcerKis (a) and of resitant strain KdrKis (b). The concentrations of IR3535 tested vary from 1000 to 5000 mg/L. Mean±S.E.M, N between 2 and 10 replicates of 50 to 100 individuals. Mann-Whitney: NS Not significant.

FIG. 14. Effects of the ternary combination IR3535/thiacloprid/thiamethoxam on the Anopheles gambia larvae of resistant strains AcerKis and KdrKis. Comparative histograms illustrate the effect of the ternary combination of IR3535/thiacloprid/thiamethoxam on the mortality of Anopheles gambia larvae of resistant strain AcerKis (a, b) and of resitant strain KdrKis (c, d) measured at 24 hours and 48 hours. Thiacloprid and thiamethoxam concentrations were 0.01 mg/L and 0.01 mg/L (a, c) and 0.01 mg/L and 0.02 mg/L (b, d), respectively. The IR3535 concentrations tested vary from 1 to 500 mg/L. Mean±S.E.M, N between 3 and 10 replicates of 50 to 100 individuals. Mann-Whitney: * p-value<0.05; ** p-value<0.01; NS Not significant.

### DETAILED DESCRIPTION OF THE INVENTION

The present invention relates to synergistic combinations useful as insecticides and larvicides against mosquitoes, including insecticide-resistant mosquitoes.

### I—Synergistic Combinations

The present invention provides synergistic combinations consisting of a binary mixture or association of thiacloprid and thiamethoxam or consisting of a ternary mixture or association of thiacloprid, thiamethoxam, and IR3535.

As used herein, the term “synergistic” means the enhanced or magnified effect of a combination on at least one property compared to the sum of the individual effects of each component of the combination. In the context of the present invention, the synergistic effect relates to the insecticidal or larvicidal properties. The synergistic effect may be at least about 5%, at least about 10%, at least about 20%, at least about 30%, at least about 40%, at least about 50%, at least about 60%, at least about 70%, at least about 80%, at least about 90%, at least about 100%, at least about 200%, at least about 500%, or at least about 1000% greater than the corresponding additive effect. The terms “approximately” and “about”, as used herein in reference to a number, generally include numbers that fall within a range of 10% in either direction of the number (greater than or less than the number) unless otherwise stated or otherwise evidenced from the context (except where such number would exceed 100% of a possible value).

As used herein, the term “thiacloprid” refers to an insecticide of the neonicotinoid class, whose IUPAC name is {(2Z)-3-[(6-Chloropyridin-3-yl) methyl]-1,3-thiazolidin-2-ylidene}cyanamide and which is also known as [3-[(6-Chloro-3-pyridinyl)methyl]-2-thiazolidinylidene]cyanamide. The mechanism of action of thiacloprid is similar to other neonicotinoids and involves disruption of the insect's nervous system by stimulating nicotinic acetylcholine receptors. Thiacloprid was developed by Bayer CropScience for use on agricultural crops for the control of a variety of sucking and chewing insects, primarily aphids and whiteflies. In France, thiacloprid is banned as an insecticide for agricultural use since Sep. 1, 2018.

As used herein, the term “thiamethoxam” refers to an insecticide of the neonicotinoid class developed by Syngenta. Its IUPAC name is 3-[(2-Chloro-1,3-thiazol-5-yl)methyl]-5-methyl-N-nitro-1,3,5-oxadiazinan-4-imine. Thiamethoxam is a broad-spectrum, systemic insecticide. It gets in the way of information transfer between nerve cells by interfering with nicotinic acetylcholine receptors in the central nervous system and eventually paralyzes the muscles of the insects. Thiamethoxam is approved for a wide range of agricultural, viticultural and horticultural uses in many countries. However, in April 2018, the member states of the European Union decided to ban three neonicotinoids: clothianidin, imidacloprid and thiamethoxam for use in agriculture as these insecticides are considered to pose a serious danger to honeybees and wild bees.

The terms “IR3535”, “IR3535®” and “Insect Repellent 3535” are used herein interchangeably. They refer to an insect repellent whose IUPAc name is ethyl N-acetyl-N-butyl-β-alaninate and which is also known as ethylbutylacetylaminopropionate. IR3535 is solely a repellent, it has no killing action and does not give rise to selection pressure or development of resistance. It is a colorless and almost odorless oil that is intended to be applied to the skin of humans and animals, and is safe to be used on infants as well as on pregnant and breastfeeding women. IR3535 is biodegradable and completely degraded in the environment within a very short time. It has a broad efficacy against various insects like mosquitoes, ticks, lice, and other bugs. It functions by reducing odor volatility thereby masking the ability of volatile odorants on the skin to activate olfactory neurons and attract mosquitoes.

In a synergistic combination consisting of a binary mixture of thiacloprid and thiamethoxam, the molar ratio between the two neonicotinoid molecules may be any molar ratio that results in a synergistic effect. In certain embodiments, the molar ratio between thiacloprid and thiamethoxam in a synergistic combination according to the present invention is comprised between about 0.01:1 and about 1:0.01, preferably between about 0.1:1 and about 1:0.1, for example, about 0.2:1; about 0.3:1; about 0.4:1; about 0.5:1; about 0.6:1; about 0.7:1; about 0.8:1; about 0.9:1; about 1:1; about 1:0.9; about 1:0.8; about 1:0.7; about 1:0.6; about 1:0.5; about 1:0.6; about 1:0.7; about 1:0.8; or about 1:0.9. In certain preferred embodiments, the molar ratio between thiacloprid and thiamethoxam is about 1:1, such as about 0.8:1; about 0.9:1; 1:1; about 1:0.9; or about 1:0.8.

In a synergistic combination consisting of a ternary mixture of thiacloprid, thiamethoxam and IR3535, the molar ratio between the insect repellent and the mixture of the two neonicotinoid molecules may be any molar ratio that results in a synergistic effect. In certain embodiments, the molar ratio between IR3535 and the mixture of the two neonicotinoid molecules in a synergistic combination according to the present invention is comprised between about 0.005:1 and about 0.1:1, more preferably between about 0.01:1 and about 0.1:1, for example about 0.02:1; about 0.03:1; about 0.04:1; about 0.05:1; about 0.06:1; about 0.07:1; about 0.08:1; about 0.09:1; or about 0.10:1. In the synergistic combination consisting of a ternary mixture, the molar ratio between the two neonicotinoid molecules may be any molar ratio, such as for example a molar ratio associated with a synergistic effect of the mixture of the two neonicotinoid molecules. Thus, for example, the molar ratio between the two neonicotinoid molecules in the synergistic ternary combination may be comprised between about 0.01:1 and about 1:0.01, preferably between about 0.1:1 and about 1:0.1, as described above.

### II—Mosquito Insecticides

The present invention provides mosquito insecticides (adulticides and larvicides) comprising a synergistic combination as defined above. Generally, a mosquito insecticide according to the present invention comprises an efficient amount of a synergistic combination as defined above and at least one carrier.

### A. Mosquitoes

The term “mosquito”, as used herein, refers to an insect that belongs to the Culicidae family. Typically, a mosquito's life cycle includes four separate and distinct stages: egg, larva, pupa, and adult, the entire process taking about a month. A mosquito's life cycle begins when eggs are laid on a water surface (e.g., Culex, Culiseta, and Anopheles species) or on damp soil that is flooded by water (e.g., Aedes species). Most eggs hatch into larvae within 48 hours. The larvae live in the water, feeding on microorganisms and organic matter and come to the surface to breathe. They shed their skin four times growing larger after each molting and on the fourth molt, the larva changes into a pupa. The pupal stage is a resting, non-feeding stage of about two days. When development is complete, the pupal skin splits and the mosquito emerges as an adult. Unless otherwise stated, the term “mosquito”, as used herein, refers to an insect at either one of these different life cycles.

The present invention mainly concerns mosquitoes during their larval and adult stages. As used herein, the term, “mosquito larvae” refers to mosquitoes during the larval phase of their life cycle. Mosquito larvae, also known as wrigglers, live in water from 4 to 14 days depending on water temperature. They look like small hairy worms, less than a 0.6-cm long, with a large head and thorax and narrow abdomen. They typically hang upside-down near the water's surface. As used herein, the term “adult mosquitoes” refers to mosquitoes during the adult phase of their life cycle, the only stage during which the insect can fly. Adult mosquitoes live for only a few weeks. The adult females of most mosquito species have tube-like mouthparts (called proboscis) that can pierce the skin of a host and feed on blood, which contains protein and iron needed to produce eggs. The mosquito's saliva is transferred to the host during the bite and can cause an itchy rash. In addition, many species can ingest disease-causing pathogens while biting, and transmit them to future hosts.

In certain embodiments, the mosquitoes against which an insecticide according to the present invention may be used are mosquitoes that can transmit a disease to a mammalian host. Such mosquitoes may belong to a genus selected from the group consisting of the Aedes, Anopheles, Culex, Culiseta and Mansonia genuses.

Examples of mosquitoes of the Aedes genus include, but are not limited to, the following Aedes species: Aedes aegypti, Aedes albopictus, Aedes australis, Aedes cantator, Aedes cinereus, Aedes polynesiensis, Aedes rusticus, Aedes taeniorhynchus, and Aedes vexans.

Examples of mosquitoes of the Anopheles genus include, but are not limited to, the following Anopheles species: Anopheles albimanus, Anopheles arabiensis, Anopheles atroparvus, Anopheles baimaii, Anopheles balabacensis, Anopheles barberi, Anopheles bellator, Anopheles cruzii, Anopheles culicifacies, Anopheles darlingi, Anopheles dirus, Anopheles earlei, Anopheles farauti, Anopheles freeborni, Anopheles funestus, Anopheles gambiae, Anopheles intro latus, Anopheles latens, Anopheles leucosphyrus, Anopheles maculatus, Anopheles minimus, Anopheles moucheti, Anopheles nili, Anopheles punctipennis, Anopheles punctulatus, Anopheles pseudopunctipennis, Anopheles quadrimaculatus, Anopheles sergentii, Anopheles sinensis, Anopheles stephensi, Anopheles subpictus, Anopheles sundaicus, and Anopheles walkeri.

Examples of mosquitoes of the Culex genus include, but are not limited to, the following Culex species: Culex annulirostris, Culex antennatus, Culex jenseni, Culex pipiens, Culex pusillus, Culex quinquefasciatus, Culex rajah, Culex restuans, Culex salinarius, Culex tarsalis, Culex territans, Culex theileri and Culex tritaeniorhynchus.

Examples of mosquitoes of the Culiseta genus include, but are not limited to, the following Culiseta species: Culiseta incidens, Culiseta impatiens, Culiseta inornata and Culiseta particeps.

Examples of mosquitoes of the Mansonia genus include, but are not limited to, the following Mansonia species: Mansonia annulifera, Mansonia bonneae, Mansonia dives, Mansonia indiana, and Mansonia uniformis.

In certain embodiments, the mosquitoes against which an insecticide according to the present invention may be used are mosquitoes that are insecticide resistant. “Insecticide resistance” is defined as the developed ability in a strain of insects to tolerate doses of insecticide that would prove lethal to the majority of individuals in a normal (i.e., non-resistant) population of the same species. Although individuals with resistant genes to a given insecticide are rare in normal populations, widespread use of an insecticide favors the prevalence of the resistant individuals. These individuals multiply fast in the absence of intraspecific competition and, over a number of generations, quickly become the dominant proportion of the population, rendering the insecticide no longer effective. Historically, the patterns of insecticide use for controlling mosquitoes have led to the evolution of insecticide resistance to the chemical compounds DDT (dichlorodiphenyltrichloroethane), organophosphates, carbamates, and pyrethroids.

In certain embodiments, the mosquitoes against which an insecticide according to the present invention may be used are mosquitoes that are resistant to at least one insecticide selected from the group consisting of DDT, organophosphates, carbamates, and pyrethroids.

In certain preferred embodiments, the mosquitoes against which an insecticide according to the present invention may be used are mosquitoes that are resistant to at least one insecticide selected from the group consisting of organophosphates, carbamates, and pyrethroids.

For example, the mosquitoes targeted by an insecticide described herein may be resistant to organophosphate insecticides. Organophosphate insecticides target the insect's nervous system by interfering with the enzymes acetylcholinesterase and other cholinesterases, disrupting the transmission of nerve influx and killing or disabling the insect. Examples of organophosphate insecticides used alone include, but are not limited to, parathion, malathion, methyl parathion, chlorpyrifos, diazinon, dichlorvos, phosmet, fenitrothion, tetrachlorvinphos, azamethiphos, azinphos-methyl, terbufos, and temephos.

Alternatively, or additionally, the mosquitoes targeted by an insecticide described herein may be resistant to carbamate insecticides. Carbamate insecticides have similar mechanisms of action to organophosphates but have a much shorter duration of action. Examples of carbamate insecticides used alone include, but are not limited to, aldicarb, carbofuran, carbaryl, ethienocarb, fenobucarb, oxamyl, propoxur, and methomyl.

Alternatively, or additionally, the mosquitoes targeted by an insecticide described herein may be resistant to pyrethroid insecticides. Pyrethroid insecticides are nonpersistent sodium channel modulators. They are less toxic than organophosphates and carbamates. Pyrethroid insecticides have been widely used for house spraying and impregnation of mosquito nets, for example for malaria control. Examples of pyrethroid insecticides used alone include, but are not limited to, allethrin, bifenthrin, cyfluthrin, cypermethrin, cyphenothrin, deltamethrin, esfenvalerate, etofenprox, fenpropathrin, fenvalerate, flucythrinate, flumethrin, imiprothrin, metofluthrin, permethrin, resmethrin, silafluofen, simithrin, tefluthrin, tetramethrin, tralomethrin, and transfluthrin.

### B. Mosquito Insecticides and Mosquito Larvicides

The term “mosquito insecticide”, as used herein, refers to an insecticide that is able to target and kill a mosquito at at least one stage of its life cycle. In some embodiments, the mosquito insecticide is an adulticide. As used herein, the term “mosquito adulticide” refers to an insecticide that targets and kills mature adult mosquitoes (i.e., mosquitoes that have shed their pupal skin). In other embodiments, the mosquito insecticide is a larvicide. As used herein, the term “mosquito larvicide” refers to an insecticide that targets and kills mosquito larvae (i.e., mosquitoes during a period which starts after egg hatching and which ends when the larva changes into a pupa). Thus, larvicides target larvae in the breeding habitat before they can mature into adult mosquitoes and disperse.

The use of a mosquito larvicide results in a reduction in the number of larvae developing into pupa and adults. In mosquito control, larvicides have certain advantages compared to adulticides. Indeed, the control of larvae is much more efficient than that of adults: it is indeed possible to treat a very large number of larval mosquitoes in the same larval development site while adult mosquitoes tend to disperse soon after their emergence. Unlike adults, mosquito larvae do not modify their behavior to avoid control interventions that are targeted on the breeding sites (Killeen et al., Malaria J., 2002, 1: 8). The larvae control strategy also serves to extend the life of insecticides by reducing the selection pressure linked to the development of resistance. Also, the use of larvicides is less controversial than the use of adulticides. The elimination of mosquito larvae using a non-toxic formulation does not pollute aquatic environments, substantially eliminating risks of intoxication for both non-target animals and human beings.

### C. Formulation of Mosquito Insecticides

The synergistic combinations of the present invention may be employed as such. However, preferably, synergistic combinations described herein are formulated with solid and/or liquid dispersible carrier vehicles or in the form of particular dosage preparations for specific applications made therefrom, such as solutions, emulsions, suspensions, powders, pastes, and granules, which are thus ready for use. In certain embodiments, the synergistic combination is the sole active ingredient in the mosquito insecticide. In other embodiments, the synergistic combination is combined with at least one additional biologically active agent.

1. Concentrations of Binary and Ternary Synergistic Combinations in Mosquito Insecticides. As indicated above, a mosquito insecticide (adulticide or larvicide) according to the present invention comprises an efficient amount of a synergistic combination as defined above. The term “efficient amount”, as used herein, refers to any amount of the synergistic combination that is sufficient to fulfill its intended purpose(s), e.g., a desired response in a mosquito (e.g., a mosquito larva) or in a mosquito population (e.g., mosquitoes resistant to a given insecticide). It will be recognized by one skilled in the art that the mosquito insecticide may be in a concentrated form to be diluted at the time of application. In such cases, the efficient amount corresponds to the concentration after dilution.

In a mosquito insecticide (adulticide or larvicide) according to the present invention, the binary synergistic combination of thiacloprid and thiamethoxam or the ternary synergistic combination of thiacloprid, thiamethoxam and IR3535 may be present at any concentration that is sufficient to achieve the desired goal. For example, in a mosquito insecticide comprising a synergistic combination consisting of a binary mixture of thiacloprid and thiamethoxam, the concentration of each of the neonicotinoid molecules may be comprised between about 10⁻⁹ M and about 10⁻⁵ M. Preferably, the concentration of each of the neonicotinoid molecules is comprised between about 5·10⁻⁸ M and about 5·10⁻⁶ M. For example, in a mosquito insecticide comprising a synergistic combination consisting of a ternary mixture of thiacloprid, thiamethoxam and IR3535, the insect repellent may be present at a concentration comprised between about 5·10⁻¹² M and about 5·10⁻⁹M, preferably between about 10⁻¹¹ M and about 5·10⁻¹⁰ M. At these concentrations, IR3535 is at a sub-repellent concentration against insects, i.e., it has no repellent efficacy and no insecticide efficacy alone against insects, in particular against mosquitoes. In the mosquito insecticide, the concentration of each of the two neonicotinoid molecules may be comprised between about 10⁻¹⁰ M and about 10⁻⁶ M, for example between about 10⁻⁹ M and about 5·10⁻⁷ M.

In certain embodiments, the mosquito insecticide comprises an in vivo ternary synergistic mixture of thiacloprid, thiamethoxam and IR3535, the concentration of IR3535 is 100 mg/L (4.6·10⁴M), the concentration of thiacloprid is 0.01 mg/L (4·10⁻⁸M) or less, and the concentration of thiamethoxam is 0.02 mg/L (6.9·10⁻⁸M) or 0.01 mg/L (3.4·10⁻⁸M) or less.

The use of such very low concentrations lessens the risk of toxicity to humans or non-target animals.

2. Formulations of Mosquito Insecticides. A mosquito insecticide according to the present invention may be formulated in any manner that can be suitably applied to standing water or other mosquito habitats. For example, mosquito insecticides according to the present invention may be formulated as solutions, concentrated liquids, emulsions, suspensions, emulsifiable concentrates, spray-dried concentrates, spray powders, soluble powders, wettable powders, dusting powders, granules, dry flowables, wettable granules, water dispersible granules, pellets, non-aqueous suspensions, briquettes, foams, pastes, aerosols, water soluble pouches, tablets, floating formulations, sustained release formulations, and formulations used with burning equipments, such as fumigating cartridges, fumigating cans and fumigating oils, as well as ULV (Ultra-Low Volume) cold mist and warm mist formulations, or any combination thereof.

Since mosquito larvae are generally found in water, larvicides are preferably formulated so that they are particularly effective for use in water. Accordingly, formulations used as larvicides are preferably water-soluble or water miscible. Liquid treatments can be applied by spraying. Formulations include water-soluble powders, soluble liquid concentrates, wettable powders or water-dispersible granules. Solid formulations such as a granules or briquettes, where the active ingredient is mixed with bulking agents such as sawdust, sand or plaster, can easily be used by introduction of the formulation into water containers such as tanks or latrines. On the other hand, emulsifiable concentrates are generally ineffective for long term use in water as larvicides since they will settle after about 24 hours. For the treatment of water, it is of particular benefit to formulate larvicide compositions so that the active ingredients will be released slowly over a period of time. This avoids the need for continuous re-treatment.

Carriers. As indicated above, a mosquito insecticide (adulticide or larvicide) according to the present invention comprises an efficient amount of a synergistic combination as defined above and at least one carrier. As used herein, the term “carrier” refers to a carrier medium which does not interfere with the effectiveness of the insecticidal/larvicidal activity of the active ingredient(s) and which is not excessively toxic to the environment and/or the non-targeted human or animal populations at the concentration at which it is used. The term includes solvents, dispersion media, coatings, and the like. The use of such media and agents for insecticides is well known in the art (see for example, “Pesticide Formulation and Adjuvant Technology”, Chester et al., 1996, CRC Press, Boca Raton; “The Pesticide Book”, Ware, 2000, 5^{th} Ed., Thomson Publications, Fresno, Calif.).

The carrier may be an aqueous liquid carrier, such as water, a saline, a gel, an inert powder, a zeolite, a cellulosic material, a microcapsule, an alcohol such as ethanol, a hydrocarbon, a polymer, a wax, a fat, an oil, a protein, a carbohydrate, and any combination thereof. A carrier may include time release materials, such that a synergistic combination is released over a period of hours, or days, or weeks. Other contemplated carriers include those that wholly or partially solubilize and/or liquefy the synergistic combination within a composition. Examples of such carriers include, but are not limited to, water, aqueous solvents (e.g., mixture of water and ethanol), ethanol, methanol, chlorinated hydrocarbons, ethyl acetate, petroleum solvents, turpentine, xylene, and combinations thereof. Organic solvents are used mainly in the formulation of emulsifiable concentrates, ultra-low volume (ULV) formulations, and to a lesser extent, granular formulations. Exemplary organic solvents include, but are not limited to, aromatic solvents (e.g., xylene), and chlorinated hydrocarbons. The carrier may be a liquid carrier combined with a surfactant capable of dispersing the synergistic combination throughout the liquid carrier. Alternatively, or additionally, the synergistic combination may be encapsulated in micro- or nano-capsules and the capsules are dispersed in an aqueous carrier.

Non-toxic, biodegradable carriers are preferably employed in the formulation of a mosquito insecticide of the present invention such that the insecticide can be applied to water reservoirs or other mosquito breeding sites or habitats without harm to the environment, such as flora and fauna other than the targeted insects.

A carrier or a carrier mixture may be present in a composition in an amount of about 10%, or about 15%, or about 20%, or about 25%, or about 30%, or about 50%, by weight of the composition. In other embodiments, the carrier or carrier mixture may be present in an amount that is at least or greater than about 30%, about 70%, about 80%, about 90%, about 95%, or about 99% by weight of the composition. In yet other embodiments, the carrier or carrier mixture may be included in an amount such that when added to the amount of synergistic combination included in the composition amounts to 100% of the volume.

In certain embodiments, a mosquito insecticide according to the present invention is in a liquid form, wherein the synergistic combination is either solubilized in an organic phase or encapsulated in micro- or nano-capsules.

Other Components and Additives. A mosquito insecticide according to the present invention may be formulated in the presence of at least one other compound or agent selected from the group consisting of stabilizers, preservatives, antioxidants, surfactants, waxy substances, and any combination thereof.

A stabilizer can be used to regulate the particle size of a concentrate and/or to allow the preparation of a stable suspension. Examples of suitable stabilizers include, but are not limited to, ethylene oxide and propylene oxide copolymer, polyalcohols, starch, maltodextrin and other soluble carbohydrates or their ethers or esters, cellulose ethers, gelatin, polyacrylic acid and salts and partial esters thereof and the like. The stabilizer can include polyvinyl alcohols and copolymers thereof, such as partly hydrolyzed polyvinyl acetate. The stabilizer may be used at a level sufficient to regulate particle size and/or to prepare a stable suspension, e.g., between 0.1% and 15% of the aqueous solution.

One or more preservatives may be present in a mosquito insecticide according to the present invention. As used herein, the term “preservative” refers to a material that prevents the growth and/or reacts with and/or destroys microorganisms that might damage or grow on or in the composition or otherwise contaminate it. Examples of preservatives include, but are not limited to, antimicrobial agents (e.g., quaternary ammonium compounds), alcohols, chlorinated phenols, parabens and paraben salts, imidazolidinyl urea, phenoxyethanol, p-hydroxybenzoate, organic acids, small carboxylic acids like benzoic acid, citric acid, lactic acid, sorbic acid, salicylic acid, formic acid, propionic acid or corresponding salts. Formaldehyde-releasers and isothiazolinones may also be used. Other typical non-limiting examples include diazolidinyl urea, imidazolidinyl urea, formaldehyde, propylparaben, ethylparaben, butylparaben, methylparaben, benzylparaben, isobutylparaben, phenoxyethanol, sorbic acid, benzoic acid, methylchloro-isothiazolinone, methylisothiazolinone, methyl dibromoglutaronitrile, dehydroacetic acid, sodium bisulfite, dichlorophen, caprilyl glycol, salts of any of the foregoing compounds, and mixtures of any of the foregoing compounds. A preservative, when present, is typically used in an amount of from about 0.01% to about 5% w/w.

A mosquito insecticide according to the present invention may contain one or more antioxidants. As used herein, the term “antioxidant” refers to a compound or agent that typically inhibits oxidation of an oxidation-susceptible compound by reacting preferentially with the oxidizing agent before the oxidizing agent reacts with the compound. Suitable water-soluble antioxidants include, but are not limited to, ascorbic acid, erythorbic acid, a botanical extract (such as rosemary extract, green tea extract, or other extract containing a polyphenol antioxidant), and combinations thereof. Suitable oil soluble antioxidants include, but are not limited to, vitamin E, tocopherols, ascorbyl palmitate, butylated hydroxyanixole (BHA), butylated hydroxytoluene (BHT), pentaerythrityl tetra-di-t-butyl hydroxyhydrocinnamate, and any combination thereof. An antioxidant, when present, is typically used in an amount of from about 0.01% to about 1% w/w, typically about 0.1% w/w.

A mosquito insecticide according to the present invention may contain at least one surfactant. The terms “surfactant” and “surface active agent” are used herein interchangeably and refer to amphilic compounds that have at least one hydrophobic tail and at least one hydrophilic head, and more typically a single hydrophobic tail and a single hydrophilic head. Surfactants typically act to lower surface tension and can provide wetting, emulsification, and foam. A surfactant may be zwitterionic, amphiphilic, cationic, anionic, non-ionic, or combinations thereof. Examples of surfactants include, but are not limited to, polyacrylic acid salts, lignosulphonic acid salts, phenolsulphonic or (mono- or di-alkyl)naphthalenesulphonic acid salts, laurylsulfate salts, polycondensates of ethylene oxide with lignosulphonic acid salts, polycondensates of ethylene oxide with fatty alcohols or with fatty acids or with fatty amines, substituted phenols (in particular alkylphenols or arylphenols such as mono-and di(polyoxyalkylene alkylphenol) phosphates, polyoxyalkylene alkylphenol carboxylates or polyoxyalkylene alkylphenol sulfates), salts of sulphosuccinic acid esters, taurine derivatives (in particular alkyltaurides), polycondensates of ethylene oxide with phosphated tristyrylphenols and polycondensates of ethylene oxide with phosphoric esters of alcohols or phenols. The presence of at least one surfactant is often required when the active substance is not soluble in water and the carrier agent for the application is water. When present, a surfactant is typically used in a total amount of from about 0.5% w/x to about 20% w/w.

A waxy substance can be used as a carrier in a sprayable composition. The waxy substance can be, for example a biodegradable wax, such as bees wax, carnauba wax and the like, candelilla wax (hydrocarbon wax), montan wax, shellac and similar waxes, saturated or unsaturated fatty acids, such as lauric, palmitic, oleic or stearic acid, fatty acid amides and esters, hydroxylic fatty acid esters, such as hydroxyethyl or hydroxypropyl fatty acid esters, fatty alcohols, and low molecular weight polyesters such as polyalkylene succinates.

Examples of other additives suitable for use in a mosquito insecticide according to the present invention include, but are not limited to, one or more fillers (e.g., mineral clays such as attapulgite), one or more gelling agents or thickeners (e.g., methyl cellulose, ethyl cellulose, sodium carboxymethyl cellulose (SCMC); hydroxyethyl cellulose (HEC), and any combination thereof; montmorillonite (such as bentonite; magnesium aluminum silicate; and attapulgite); polysaccharides extracted from seeds and seaweeds; guar gum, locust bean gum, carrageenam, alginates, modified starches, polyacrylates, polyvinyl alcohol, polyethylene oxide, and xanthan gum); one or more binders (e.g., synthetic or natural resins, polyvinylpyrrolidone, polyvinyl alcohol, partially hydrolyzed polyvinyl acetate, carboxymethylcellulose, starch, vinylpyrrolidone/vinyl acetate copolymers and polyvinyl acetate, or combinations thereof); one or more lubricants (e.g., magnesium stearate, sodium stearate, talc or polyethylene glycol, or combinations thereof); one or more antifoam agents (e.g., silicone emulsions, long-chain alcohols, phosphoric esters, acetylene diols, fatty acids or organofluorine compounds); one or more complexing agents (e.g., salts of ethylenediaminetetraacetic acid (EDTA), salts of tri-nitrilotriacetic acid, salts of polyphosphoric acids, or combinations thereof); one or more wetting agents (e.g., sodium lauryl sulfate, sodium dioctyl sulphosuccinate, alkyl phenol ethoxylates and aliphatic alcohol athoxylates); one or more emulsifying agents (e.g., alkylphenol or aliphatic alcohol with 12 or more ethylene oxide units and the oil-soluble calcium salt of dodecylbenzene sulphonic acid); and/or one or more dispersing agents.

Depending on the formulation of a mosquito insecticide, one skilled in the art knows how to select appropriate additives and their respective amounts.

Additional Biologically Active Agents. In certain embodiments, a mosquito insecticide according to the present invention further comprises at least one additional biologically active agent. Suitable biologically active agents include, but are not limited to, mosquito attractants, insect feeding stimulants, and insect sterilants.

For example, a mosquito attractant may be added to a mosquito insecticide according to the present invention—the mosquito attractant being used as a bait or lure. As used herein, the term “attractant” refers to any compound, composition or combination capable of attracting insects such as mosquitoes. As used herein, a “bait” or “lure” is an attractant capable of attracting insects such as mosquitoes to specific location or trap. For example, chemical attractants, such as pheromones, can be added to mosquito larvicide of the present invention and the larvicide may be used in combination with a trap, an egg laying structure or a mosquito breeding container. Other types of attractants can also be used, such as hay infusion, which can be added directly to the aqueous medium. Hay infusion comprises hay which has been soaked in water for an extended period of time.

For example, an insect feeding stimulant may be added to a mosquito insecticide according to the present invention. Insect feeding stimulants include, but are not limited to, crude cottonseed oil, fatty acid esters of phytol, fatty acid esters of geranyl geraniol, fatty acid esters of other plant alcohols, plant extracts, and combinations thereof.

For example, an insect sterilant may be added to a mosquito insecticide according to the present invention. An insect sterilant is a compound, agent or combination thereof that sterilizes an insect or otherwise block its reproductive capacity, thereby reducing the population in the following generation.

Encapsulation. A mosquito insecticide according to the present invention may be formulated such that at least the synergistic combination is encapsulated in microcapsules. As used herein, the term “encapsulation” refers to a process whereby small particles or droplets of an active or useful substance (“core”) are coated with or embedded in a polymer (“shell”). The core material is released from the microcapsule through erosion, permeation or rupture of the shell. Variations in the thickness or material of the shell can be utilized to control the rate or timing with which the core material is released from the capsule. As used herein, the term “microcapsule” refers to a structure having a polymeric membrane (“shell”) surrounding a core material (here a mosquito insecticide). The term “microcapsule” is intended to be generic and is not limited to a particular size (i.e., nano, micro, etc). Microcapsules may have diameters from about 100 nm to about 2,000 μm.

Encapsulation can be accomplished using any of the various methods known in the art, such as via an emulsification process, an interfacial polymerization or a polycondensation. Microencapsulation can be performed with a microencapsulation device, including microfluidic droplet generation or encapsulation device.

The microcapsules can be made from a wide variety of polymeric materials including, but not limited to, celluloses, proteins such as casein, fluorocarbon-based polymers, hydrogenated rosins, lignins, melamine, polyurethanes, vinyl polymers such as polyvinyl acetate (PVAC), polycarbonates, polyvinylidene dinitrile, polyamides, polyvinyl alcohol (PVA), polyamide-aldehyde, polyvinyl aldehyde, polyesters, polyvinyl chloride (PVC), polyethylenes, polyethylene oxides, polystyrenes, polyvinylidene, silicones, and combinations thereof. Examples of celluloses include, but are not limited to, methylcellulose, ethyl cellulose, cellulose acetate, cellulose acetate-butyrate, cellulose acetate-propionate, cellulose propionate, and combinations thereof.

When present, additives may be included in the formulation in encapsulated form. The additives may be encapsulated alone, separately, or in individual groups. Encapsulation strategy may depend on the release profile sought for the material

Granules and Smart Granules. In certain embodiments, a mosquito insecticide according to the present invention is formulated as granules. Granules can either have the synergistic combination impregnated on a pre-formed granule or they can be mixed with a filler to form slow-release granules. Granules can be formulated so that the synergistic combination is released at a specific time by coating the granules with a polymer which will be broken down over a predictable time. Appropriate polymers are known to those skilled in the art. The size of granules is generally in a range of 250-1,000 microns with at least 90% of the granules within the specified mesh size range. The large size of granules prevents them from drifting in the wind, resulting in much less loss of insecticide then with powder and liquid formulations. The active ingredient in granules is usually present in a concentration of from about 1% to about 40% w/w.

Different methods for the preparation of granular formulations are known in the art, including coating, wherein a fine powder of a synergistic combination is coated onto carrier granules, e.g., sand, in a blender using sticker solutions. Another method of impregnation involves spraying a solvent-based solution of a synergistic combination onto an absorbent carrier in a blender. Granules can also be prepared by extrusion wherein a synergistic combination with low water solubility can be processed by mixing a powder blend with a small amount of water to form a paste, which is then extruded and dried if necessary. In each method, the resultant granules can be spray-coated with resins or polymers to control the rate of release of the synergistic combination after application.

For example, a granular formulation may comprise 1-40% w/w of a synergistic combination, 1-2% w/w of stabilizer, 0-10% w/w of polymer or resin, 0-5% w/w of surfactant, 0-5% w/w of binder and up to 98% w/w carrier.

Granules may be “smart granules”, which are designed for direct application to a water body, releasing the active ingredients primary at the water surface as a floating oil. Advantageously, “smart granules” provides a thin film of oil containing the synergistic combination (and optionally other active agents) to be spread over a water surface to give a better distribution than that permitted by conventional granule formulations. The oil films are usefully sticky and resist dispersal by weather. In a typical example, an active ingredient is dissolved or dispersed in an oil or solvent of low volatility and the resultant liquid is then incorporated into a suitable granular carrier. The granule is designed to sink in water and release the active ingredients contained in the oil, which then floats to the water's surface.

Adulticide Formulations. Use of mosquito adulticides generally takes three main forms: residual surface treatment, space spraying (fogging) and use of Insecticide Treated Nets (ITNs). Bed nets are nets fixed over beds or other sleeping areas to create a physical barrier between mosquitoes and a human sleeping beneath.

In fogging, the active ingredient is formulated into oil solutions which enable them to be blown as droplets into the air. Depending on the target distance to be covered, the size of the droplet required, and the machinery available to apply it, fogging can be through the use of “mistblowers” (droplet size 50-80 μm), “foggers” (hot and cold droplets, <50 μm) or the use of “Ultra-Low Volume” (ULV) in which the amount of active ingredient is dispersed in a high volume of solvent. In public health fight against mosquitoes, the most widely used method is fogging, in particular thermal fogging (a method which uses hot air). Fogging is periodically used in areas with high mosquito numbers or during outbreaks of diseases. Therefore, a mosquito adulticide according to the present invention may be formulated to be suitable for fogging.

The invention also relates to a mosquito insecticide comprising a synergistic combination formulated as a residual spray. In residual surface treatment, the insecticide is sprayed, usually from a hand-held pressure spray pack, onto a surface leaving a residue on the surface. In most cases, the formulation used is a wettable powder and the activity of the residual ingredient on mud walls and thatched roof material lasts around 6 months before re-treatment is required. Advantages of residual spraying over fogging include less contamination of the environment and the technique tends to expose only the females of a population of resistance selection pressure.

The invention also provides a mosquito insecticide comprising a synergistic combination which is coated on and/or absorbed into a fabric. The invention also relates to the use of a mosquito adulticide wherein the adulticide is formulated for the treatment of fabrics, such as bed nets. The fabrics coated with synergistic combination-containing compositions are generally woven materials. These fabrics may be made from natural or synthetic fibers. An untreated net, such as a bed net, only acts as a physical barrier, so if it has a hole, or it is not tucked in, the insect will still be able to enter and bite. Similarly, if a limb is placed against the net a female is generally able to bite through. To overcome these deficiencies, there has been a move in recent years to impregnate nets, preferably bed nets, with fast-acting insecticides which interact to kill any mosquito coming into contact with the surface.

Studies on malaria have shown that the use of bed nets impregnated with a contact insecticide is useful in reducing the risk of transmission of disease and the promotion of the use of insecticide-treated nets has become a key malaria control strategy adopted by the WHO. Use of Insecticide Treated Nets (ITNs) has been particularly successful in sub-Saharan Africa in reducing malaria morbidity and mortality as the local vector, Anopheles gambiae, feeds indoors very late at night. Further advantages include the fact that only females are exposed, thus reducing resistance selection pressure on both sexes, and the fact that small amounts are used in a very localized manner reducing cost and contamination. ITNs remain active for around 6 to 12 months so re-treatment is infrequent and readily achieved by re-dipping the fabric in diluted insecticide. The insecticide used for such dipping is typically formulated as an emulsifiable concentrate.

Generally, a 25-50% solution of the insecticide in a solvent is used and at least 10% solubility is typically needed to make the formulation economic to transport. In many cases, insecticides are soluble in organic solvents rather than in water. In addition to appropriate solvents, emulsifiers are added to ensure that a fine oil drop (1-2 nm) in water emulsion is produced when the formulation is diluted in water. The resultant emulsion appears opaque and does not settle for 24 hours. Emulsifiable concentrates are a convenient way of formulating water-insoluble ingredients and they do not cause nozzle abrasion. Emulsifiable concentrates are mixed with water, then the net is dipped into the solution, wrung and left to dry. Emulsifiable concentrates according to the invention are preferably a 10% or 25% solution by weight.

Adulticides are also used to impregnate not only bed nets but also other protective materials that may create a physical barrier between the human target and the mosquito, for example tents, travel bed nets, hammocks or clothing (e.g., T-shirts, shirts, pants, hats).

Aerosols. A mosquito insecticide according to the present invention is also suited for aerosol-based applications, including aerolized foam applications. Pressurized cans are the typical vehicle for the formation of aerosols. An aerosol propellant that is compatible with the insecticide composition is used. Preferably, a liquefied-gas type propellant is used. Suitable propellants include compressed air, carbon dioxide, butane and nitrogen. The concentration of the propellant in the insecticide composition is from about 5% to about 40% by weight of the insecticide composition, preferably from about 15% to about 30% by weight of the insecticide composition.

### III—Uses of Mosquito Insecticides

In certain embodiments, a mosquito insecticide (adulticide or larvicide) according to the present invention is used against mosquitoes, including against insecticide-resistant mosquitoes. A mosquito insecticide (adulticide or larvicide) according to the present invention may be used to prevent mosquito infestation. The terms “preventing”, “inhibiting” or “controlling” mosquito infestation comprises the reduction of the maturation of mosquito larvae into adults and/or the death or decreased survival of adult mosquitoes. The reduction of inhibition of mosquito infestation may be measured by reduction in the number of adult mosquitoes in a given area.

In certain embodiments, a mosquito insecticide (adulticide or larvicide) according to the present invention is used against mosquitoes capable of transmitting a disease-causing pathogen. Thus, a mosquito insecticide according to the present invention may be used to control mosquito-borne diseases. An adulticide may be used against adult mosquitoes (in particular adult female mosquitoes) that are pathogenically infected. A larvicide may be used against mosquito larvae that carry an infection (e.g., a viral infection, a nematode infection, a protozoa infection or a bacterial infection).

Thousands of mosquito species feed on the blood of various hosts. This loss of blood is seldom of any importance to the host. The mosquito's saliva is transferred to the host during the bite and can cause an itchy rash. Many mosquito species can ingest pathogens while biting and transmit them to future hosts. In this way, mosquitoes are important vectors of diseases.

### A. Pathogens

As used herein, the term “pathogen” refers to a microorganism that can produce a disease. The pathogens that can be transmitted by mosquitoes include viruses, protozoa, worms (nematodes) and bacteria.

Non-limiting examples of viral pathogens which may be transmitted by mosquitoes include the arbovirus pathogens such as Alphaviruses pathogens (e.g., Eastern Equine encephalitis virus, Western Equine encephalitis virus, Venezuelan encephalitis virus, Ross River virus, Sindbis Virus and Chikungunya virus), Flavivirus pathogens (e.g., Japanese Encephalitis virus, Murray Valley Encephalitis virus, West Nile Fever virus, Yellow Fever virus, Dengue Fever virus, St. Louis encephalitis virus, and Tick-borne encephalitis virus), Bunyavirus pathogens (e.g., La Crosse Encephalitis virus, Rift Valley Fever virus, and Colorado Tick Fever virus) and Orbivirus (e.g., Bluetongue disease virus).

Examples of worm pathogens which may be transmitted by mosquitoes include, but are not limited to nematodes (e.g., filarial nematodes such as Wuchereria bancrofti, Brugia malayi, Brugia pahangi, Brugia timori and heartworm such as Dirofilaria immitis).

Non-limiting examples of bacterial pathogens which may be transmitted by mosquitoes include gram-negative and gram-positive bacteria including Yersinia pestis, Borellia spp, Rickettsia spp, and Erwinia carotovora.

Examples of protozoa pathogens which may be transmitted by mosquitoes include, but are not limited to, the Malaria parasite of the genus Plasmodium (e.g., Plasmodium falciparum, Plasmodium vivax, Plasmodium ovale, Plasmodium malariae, Plasmodium berghei, Plasmodium gallinaceum, and Plasmodium knowlesi).

### B. Hosts

Mosquito bites can target a wide variety of hosts: vertebrates, including mammals, birds, reptiles, amphibians, and some fish, along with some invertebrates, primarily other arthropods.

As used herein, the term “host” refers to an animal or a human upon which the mosquito feeds and/or to which a mosquito is capable of transmitting a disease-causing pathogen. Non-limiting examples of hosts include humans, domesticated pets (e.g., dogs and cats), wild animals (e.g., monkeys, rodents, and wild cats), livestock animals (e.g., sheep, pigs, cattle, and horses), avians such as poultry (e.g., chickens, turkeys and ducks) and other animals such as crustaceans (e.g., prawns and lobsters), snakes and turtles. In certain preferred embodiments, the term “host” more particular refers to humans and mammals.

### C. Mosquito-Borne Diseases

As used herein, the term “mosquito-borne disease” refers to any disease caused by a pathogen and transmitted by the bite of a mosquito (and more specifically by the bite of a female mosquito that is pathogenically infected). In certain preferred embodiments, a mosquito insecticide (adulticide or larvicide) according to the present invention is used to control mosquito-borne diseases that affect mammals, in particular human beings.

Non-limiting examples of mosquitoes and the pathogens which they transmit include species of the genus Anopheles (e.g., Anopheles gambiae) which transmit malaria parasites as well as microfilariae, arboviruses (including encephalitis viruses) and some species also transmit Wuchereria bancrofti; species of the genus Culex (e.g., Culex pipiens) which transmit West Nile virus, filariasis, Japanese encephalitis, St. Louis encephalitis and avian malaria; species of the genus Aedes (e.g., Aedes aegypti, Aedes albopictus and Aedes polynesiensis) which transmit nematode pathogens (e.g., heartworm (Dirofilaria immitis)), arbovirus pathogens such as Alphaviruses pathogens that cause diseases such as Eastern Equine encephalitis, Western Equine encephalitis, Venezuelan equine encephalitis and Chikungunya disease; Flavivirus pathogens that cause diseases such as Japanese encephalitis, Murray Valley Encephalitis, West Nile fever, Yellow fever, Dengue fever, and Bunyavirus pathogens that cause diseases such as LaCrosse encephalitis, Rift Valley Fever, and Colorado tick fever.

In certain embodiments, pathogens that may be transmitted by Aedes aegypti are Dengue virus, Yellow fever virus, Chikungunya virus and heartworm (Dirofilaria immitus).

In certain embodiments, pathogens that may be transmitted by Aedes albopictus include West Nile Virus, Yellow Fever virus, St. Louis Encephalitis virus, Dengue virus, and Chikungunya virus.

In certain embodiments, pathogens that may be transmitted by Anopheles gambiae include malaria parasites of the genus Plasmodium such as, but not limited to, Plasmodium falciparum, Plasmodium vivax, Plasmodium ovale, Plasmodium malariae, Plasmodium berghei, Plasmodium gallinaceum, and Plasmodium knowlesi.

In the practice of the present invention, mosquito species able to transmit vector-borne illnesses, such as Zika virus infection, Dengue fever infection, Yellow fever, Chikungunya, West Nile virus infection, St. Louis Encephalitis, and malaria are preferably targeted.

Thus, in certain embodiments, a mosquito insecticide (adulticide or larvicide) according to the present invention is used to control Zika virus infection. The Zika virus causes a rare birth defect called microcephaly—a neurological disorder that results in babies being born with abnormally small heads and developmental issues. The Zika virus is typically transmitted by the Aedes aegypti mosquito, but it can also be spread sexually. Aedes aegypti mosquitoes are aggressive daytime biters and officials are warning people of the need to be vigilant, cover up and reapply repellent regularly. The Asian tiger mosquito (Aedes albopictus), which also transmits dengue fever and Chikungunya, may also be capable of transmitting the Zika virus. There is no vaccine, treatment or cure for the disease and travelers to infected areas are being urged to prevent mosquito bites as the best and only protection against the disease. Pregnant women are being warned against travel to countries where Zika is present because of risk to their unborn babies. Most people infected with Zika (80%) have no symptoms or do not realize that they have been infected because symptoms are typically mild. Common signs include slight fever, rash, joint pain and conjunctivitis.

In certain embodiments, a mosquito insecticide (adulticide or larvicide) according to the present invention is used to control Malaria, which is caused by parasites, primarily Plasmodium falciparum or Plasmodium vivax. Female Anopheles mosquitoes pick up the parasites by feeding on infected humans. The parasites develop in a mosquito's body for 10 to 18 days, then is passed on when the mosquito injects saliva while feeding. Once in the human body, malaria parasites migrate to the liver, where they grow and multiply. Eventually the parasites move into the blood stream to continue developing in red blood cells. As they multiply and are released, they destroy the blood cells. This is the stage when those infected begin to show symptoms such as fevers, chills, sweating, headaches and other flu-like conditions. The infection can sometimes produce even more severe reactions, including kidney failure and death, especially if left untreated. Quinine and other anti-malarial drugs cure patients by attacking the parasites in the blood.

In certain embodiments, a mosquito insecticide (adulticide or larvicide) according to the present invention is used to control West Nile virus infection, a viral infection carried in the blood of birds. Culex mosquitoes pick it by feeding on infected birds, then, after it spreads through their systems, pass it to humans through their saliva during feeding. The West Nile virus multiplies in the human blood stream and is carried to the brain, where it begins to affect the central nervous system and causes inflammation of brain tissue, known as encephalitis. If this happens, a person will develop high fever, headaches, swollen lymph nodes and stiff neck. In the most severe cases, the infection can lead to convulsions, coma and death. Even if a severely infected person survives, there is a good chance of permanent neurological damage. There is no specific treatment of West Nile virus. However, only one in 150 people infected with West Nile virus experience severe symptoms. About 80 percent of those infected show no symptoms at all, according to the CDC (Centers for Disease Control and Prevention).

In certain embodiments, a mosquito insecticide (adulticide or larvicide) according to the present invention is used to control Dengue Fever, an infection caused by one of four viruses common to tropical and subtropical climates. The disease is spread by Aedes mosquitoes in much the same way as West Nile and other encephalitic viruses. A mosquito is able to transmit dengue about a week after biting an infected person. As the dengue virus multiplies and damages cells, an infected person begins to show symptoms similar to other infections: high fever, headaches, back and joint pain, rashes and eye pain. The symptoms of dengue hemorrhagic fever include fever that lasts up to a week, followed by bruising and bleeding. The fatality rate for hemorrhagic fever is about 5 percent, according to the CDC. About 100 million people worldwide are infected with dengue each year, especially in Africa and the tropical Western Hemisphere. Hemorrhagic fever cases are estimated in the hundreds of thousands. It is more common to Southeast Asia, where children are especially susceptible. Like most viruses, there is no specific treatment. Doctors recommend acetaminophen, plenty of fluids and rest for dengue and hospitalization for hemorrhagic fever.

In certain embodiments, a mosquito insecticide (adulticide or larvicide) according to the present invention is used to control Yellow Fever, an infection from a flavivirus originally common to primates in Africa and South America. Like dengue, it is transmitted by Aedes mosquitoes, especially Aedes aegypti, the yellow fever mosquito. The virus incubates in the body for three to six days before an infected person begins to show the common infection symptoms of fever, chills, headache and nausea. There may be a short remission before the disease returns with much more serious symptoms such as nosebleeds, bloody vomit and abdominal pain. Fatality rates range from 15% to 50%. While there is no treatment for yellow fever, it is possible to be vaccinated against infection for those living in or traveling to climates where the disease is prevalent.

In certain embodiments, a mosquito insecticide (adulticide or larvicide) according to the present invention is used to control Chikungunya fever, which is caused by a virus. Like Dengue, it is transmitted by Aedes mosquitoes, especially Aedes aegypti (the yellow fever mosquito) and Aedes albopictus (the Asian tiger mosquito). The incubation period is usually 3-7 days and symptoms can include sudden fever, joint pain with or without swelling, chills, headache, nausea, vomiting, lower back pain and a rash. There is currently no vaccine to prevent Chikungunya. Management of the disease includes rest, fluids and medications to relieve the symptoms of fever and pain, such as ibuprofen, naproxen and paracetamol.

### D. Application of Mosquito Insecticides

A mosquito insecticide comprising a synergistic combination according to the present invention may be applied to mosquitoes and/or mosquito breeding sites. For example, a mosquito insecticide according to the present invention may be applied to a mosquito or a mosquito infested area or portion thereof, to a connected water system, to a mosquito breeding site or portion thereof, to a surface area and/or material that mosquitoes may attempt to traverse or inhabit, or to surfaces and objects on which mosquitoes may be observed or that could act as vectors for their transportation. Examples of such surfaces include, without limitation, moist soils, tree holes, water surfaces (e.g., of ponds, lakes, swamps, canals, lagoons, rivers, creeks, ditches, irrigation channels, marshy areas, and the like), the edges of water bodies (e.g., shorelines, pool liners and covers, banks, etc), and the surfaces of objects that can create a pool of water (e.g., animal troughs, ornamental ponds, swimming pools, catch basins, paddling pools, rain barrels, gutters, fountains, downspouts, potted plants, or any surface of equipment or tool used in conjunction with any of the aforementioned objects). A mosquito adulticide or larvicide may be applied directly on such surfaces whether or not the presence of adult mosquitoes and/or mosquito larvae is evident.

A mosquito insecticide according to the present invention may be used in association with one or more traps. As used herein, the term “trap” refers to any device and/or object used for attracting, capturing and/or killing mosquitoes. Insect traps are well known in the art (e.g., the traps used to attract insect species of the order Lepidoptera) and are commonly used in many countries in insect eradication programs. In addition to containing a mosquito insecticide, a trap may contain an attractant which may be used as a bait or lure (or the mosquito insecticide may contain an attractant). Lure/attract-and-kill techniques are known in the art—once the insect is attracted to a lure, it is subjected to the mosquito insecticide. In certain embodiments, the trap is an ovitrap. As used herein, the term “ovitrap” has its art understood meaning and refers to a dark container containing water where mosquitoes can lay their eggs. The eggs then fall through a mesh into the water and then hatch into larvae. In the context of the present invention, ovitraps may be used to attract mosquitoes to lay their eggs in larvicide-treated water.

Treatment of mosquito infestation may be routine, or prophylactic based on changing environmental conditions (such as raised humidity or temperature), seasonal changes, observation of mosquito larvae, or in response to large numbers of adult mosquitoes. A mosquito larvicide according to the present invention may be applied during a season of high breeding activity of mosquitoes. A mosquito larvicide according to the present invention may be applied to a surface of mosquito breeding site once the temperature of said surface or mosquito breeding site reaches a temperature range suitable for the hatching of eggs and survival of larval stage insects. For example, in certain embodiments, a first treatment may be applied once the water temperature of a body of water suitable for acting as a habitat of mosquito larvae is greater than 16° C., or greater than 17° C., or greater than 18° C., or greater than 19° C. (the minimum water temperature required to sustain the larval stage of mosquito life cycle varies with the specific mosquito species).

A mosquito insecticide according to the present invention may be applied about once a day, about once every 3 days, about twice a week, about once a week, about once per two weeks, about once a month, about once per two months, about once a trimester, or about once per season. In certain embodiments, a mosquito insecticide according to the present invention may be applied with a frequency calculated such that if a first treatment is applied to a given surface or mosquito breeding site, a second treatment may be applied to the same surface or mosquito breeding site before the end of the adult stage as counted from the day before the first treatment was applied. In this manner, the first treatment is effective against larvae present at that time, and the second treatment is effective against larvae resulting from eggs laid by mature mosquitoes of the last generation immediately prior to the first treatment that would have been in adult form during the first treatment. The repetition of the treatment may continue beyond the timeline of the adult life stage to prevent insects from untreated mosquito breeding sites laying eggs in the previously treated mosquito breeding site. This strategy is preferably used when there are multiple mosquito breeding sites with at least one inaccessible mosquito breeding site, and/or some difficult to treat mosquito breeding sites.

A mosquito insecticide according to the present invention may be carried out using any suitable or desired manual or mechanical technique including, but not limited to, spraying, soaking, brushing, dressing, dripping, coating, spreading, applying as small droplets, a mist or an aerosol. The application may be performed using any suitable dispenser known in the art. Examples of dispensers include, but are not limited to, aerosol emitters, hand-applied dispensers, truck-, aircraft- or boat-mounted sprayers, crop dusters, irrigation sprayers, and floating dispensers Examples of aerosol emitters and hand-applied dispensers include, but are not limited to, backpack sprayers, spray bottles, brushes, droppers, sponges, pressurized dispensers, aerosol cans, roll on bottles, wipes, tissues, and the like. A dispenser for use at the edge of a body of water may be in the form of a spike or similar device that can be driven into the bed of the body of water or at the end of the body of water. The mosquito insecticide within the device can then leach out into the body of water to effectively treat any present mosquito or larvae and prevent further infestation of the connected water system or mosquito breeding site.

A dispenser or applicator used to apply a mosquito insecticide according to the present invention may be reused (for example after being refilled). Alternatively, a dispenser or applicator may be a single-use device or substance that functions as mosquito insecticide carrier that is, itself, dispensed or degraded. For example, a dispenser or applicator can be a dissolvable vehicle such as a pouch, a puck, a pellet, a block, a granule, a vesicle, or a capsule that contains at least one additional substance (i.e., a carrier) that contributes to at least one of the structure of the dispenser or applicator or a controlled release of the mosquito insecticide from the dispenser or applicator.

The invention will be further illustrated by the following examples.

### EXAMPLES

The following examples describe some of the preferred modes of making and practicing the present invention. However, it should be understood that the examples are for illustrative purposes only and are not meant to limit the scope of the invention.

### Example 1: Preliminary Results

### Materials and Methods

Studies of synergistic effects were carried out in parallel on a strain of mosquito Anopheles gambiae sensitive Kis (for Kisumu) (i.e., a strain that is not resistant to an insecticide) and a strain of resistant mosquitoes AcerKis (resistance to organophosphates and carbamates) which today constitute the largest populations of resistant mosquitoes in the world.

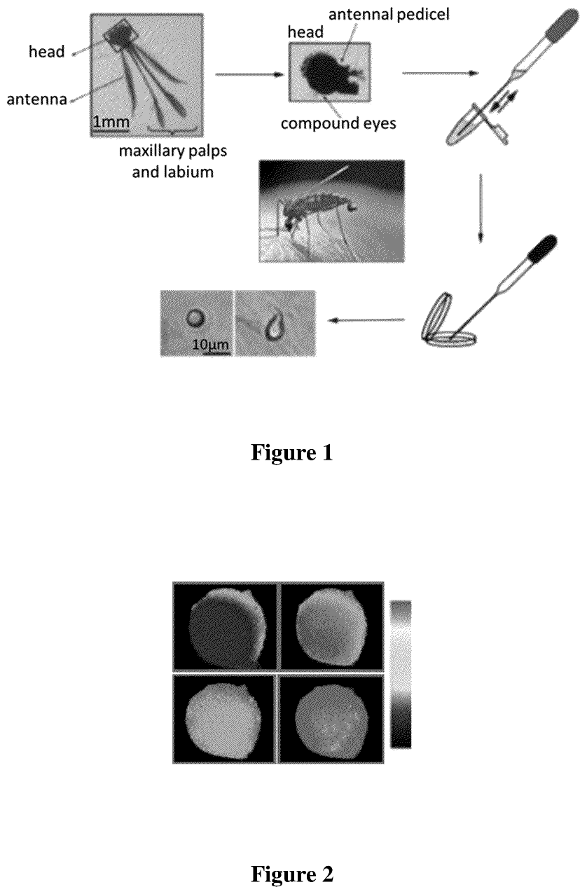

Cell Model. The cell model that was used corresponds to a population of adult female mosquitoes Anopheles gambiae (Kis and AcerKis). Nerve cells, isolated from these mosquitoes, are commonly used to study the mode of action of molecules with insecticidal effect because they express membrane receptors, targets of repellents and insecticides. In addition, it is easy to maintain them in short-term culture, due to the development of a mechanical dissociation protocol for mosquito heads (see FIG. 1).

Calcium Imaging Techniques. The calcium imaging technique adapted on mosquito neurons that was used in the present study is a technique allowing the visualization of the variations of intracellular calcium in a cell that are involved in the synergistic effect. Calcium plays an essential role in calcium-dependent intracellular signaling and involved in regulating the sensitivity of targets to insecticides (Raymond et al., Curr. Med. Chem., 2017, 24: 2974-2987). The measurement of variations in intracellular calcium within the neuronal cell bodies is possible thanks to the use of calcium-specific fluorescent indicators. In the case of mosquito neurons, the fluorescent marker Fura-2-AM was used. It allows spatio-temporal ratiometric measurements of variations in intracellular calcium. This so-called “double excitation/single emission” probe has the particularity of transmitting at two distinct wavelengths depending on its conformation. When in free form, Fura-2 has a maximum excitation wavelength at 380 nm, while in its calcium-bound form, its excitation wavelength is at 340 nm. In both cases, the emission wavelength for recording the fluorescence emitted is 510 nm. The use of this double excitation therefore makes it possible to calculate a ratio between the fluorescence emitted at 340 nm and at 380 nm (R=340/380) which reflects the variations in calcium (see FIG. 2) observed in the presence of different pharmacological agents.

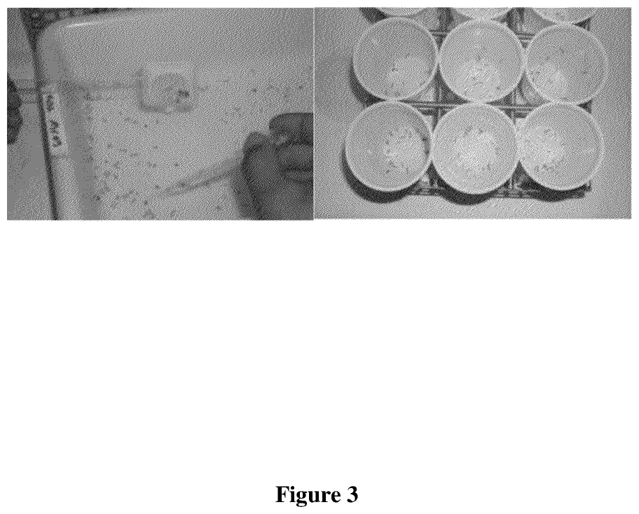

Larval Testing Protocol. The larval sensitivity test or cup test, which was used in the present study, assesses the sensitivity of mosquito larvae to insecticides and repellents. The larvae were placed in cups containing 100 mL of osmosis water added with the substance to be tested or with only solvent in the case of the controls (see FIG. 3). Four containers (cups) of 25 larvae were exposed to one modality, for a total of 100 larvae. The mortality rate was observed 24 hours after exposure to the insecticide. The mosquitoes used were late L3/early L4 larvae (last larval stages) of Anopheles gambiae, sensitive Kis reference strain and a resistant strain AcerKis, grown in the MIVEGEC laboratory under standardized conditions.

### Results

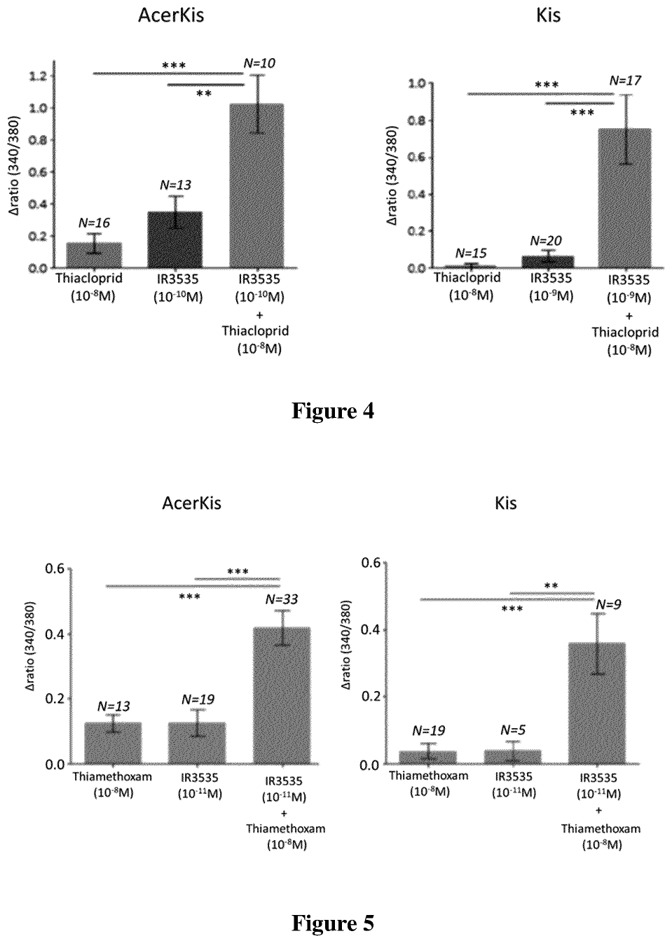

Synergistic Effects Observed in vitro on Neurons isolated from Mosquitoes Kis and AcerKis following the Application of the mixtures IR3535/thiacloprid and IR3535/thiamethoxam. A synergistic effect of IR3535 has been demonstrated, in particular on the neurons of AcerKis mosquitoes, on the actions of thiacloprid (see FIG. 4) and thiamethoxam (see FIG. 5). The concentrations of the various compounds which make it possible to obtain the best synergy, under the experimental conditions used, are summarized in Table 1.

TABLE 1
Associations IR3535/neonicotinoïde that produce a synergic effect
in vitro on mosquitoes of the AcerKis and Kis strains, ND: not determined.

| | AcerKis strain | Kis strain |
|---|---|---|
| IR3535/thiacloprid | 10⁻¹⁰ M/10⁻⁸ M | 10⁻⁹ M/10⁻⁸ M |
| IR3535/thiamethoxam | 10⁻¹¹ M/10⁻⁸ M | 10⁻¹¹ M/10⁻⁸ M |
| IR3535/thiacloprid/thiamethoxam | ND | 10⁻¹¹ M/10⁻⁹ M/10⁻⁹ M |

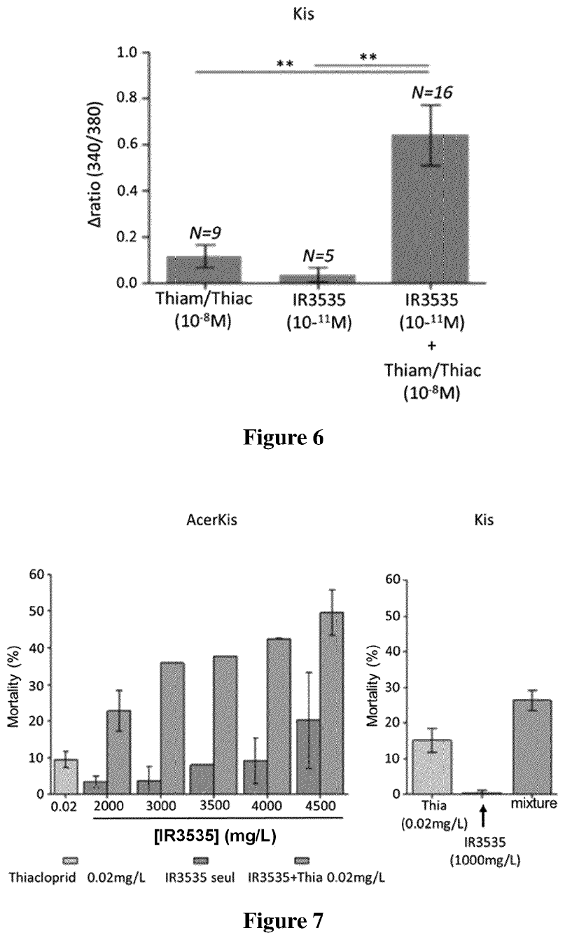

Preliminary studies have revealed that the triple association IR3535/thiacloprid/thiamethoxam induces a much greater synergy than a double association of IR3535 with one or the other of the two neonicotinoids (see FIG. 6). These preliminary studies were carried out only on Kis mosquitoes. The advantage of using the two neonicotinoids in combination is that the greater synergistic effect on mortality was obtained with insecticide concentrations 10 times lower for the Kis strain.

Synergistic Effects observed in vivo on Kis and AcerKis Mosquito Larvae Following the Application of IR3535/thiacloprid et IR3535/thiamethoxam mixtures. The main results were obtained on Kis and AcerKis mosquito larvae. Indeed, it was not possible to observe synergistic effects on adult Kis and AcerKis mosquitoes under the experimental conditions used. On the other hand, on the Kis and AcerKis mosquito larvae, the application of the IR3535/thiacloprid mixture was found to induce a very significant synergistic effect on AcerKis mosquito larvae compared to that obtained on the Kis mosquito larvae (see FIG. 7).

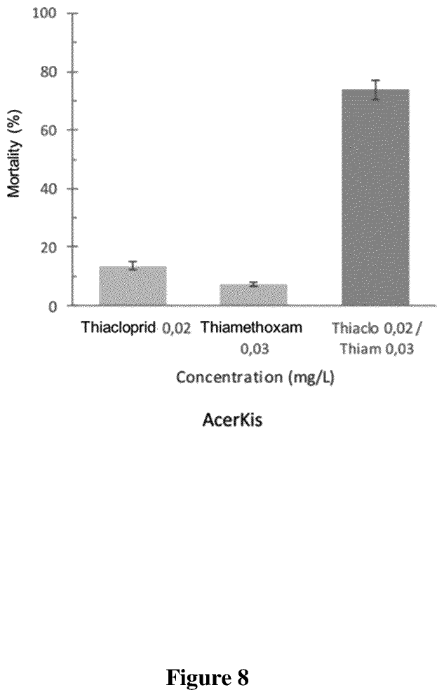

Synergistic Effects observed in vivo on AcerKis Mosquito Larvae Following the Application of a thiacloprid/thiamethoxam mixture. As indicated above in the case of studies carried out in vitro on neurons of Kis and AcerKis mosquitoes, the association of the two neonicotinoids tested in vivo on mosquito larvae AcerKis results in a much larger effect (see FIG. 8).

### Example 2: Ternary Synergistic Combination of Thiacloprid, Thiamethoxam and IR3535

The major advantage of the triple combination of compounds having different membrane targets and/or sites of action makes it possible to break the cycle of resistance development observed for a specific target and a given insecticide.

The present study concerns in vivo experiments on mosquito larvae. The main objectives of the tests preformed were to determine the effect of the triple combination IR3535/thiacloprid/thiamethoxam on the mortality of Anopheles gambiae mosquito larvae of the AcerKis (resistance to organophosphates and carbamates) and KdrKis (resistance to pyrethroids) strains, compared to the standard sensitive strain Kis. The objectives were:

1) Evaluation of the effects of IR3535, thiacloprid and thiamethoxam, used alone or in combination, on the mortality of larvae of the resistant strains AcerKis and KdrKis, 2) Determination of the best concentration(s) of each of the compounds used in the triple combination to produce an optimum potentiating synergy on the mortality of the larvae of the different strains of mosquitoes.

The larval sensitivity tests in vivo were first carried out on the larvae of the resistant strains AcerKis and KdrKis, since it is these two strains which are of major interest in vector control. The sensitive Kis strain is exclusively a reference strain in the laboratory—it is no longer present in nature.

### Materials and Methods

Methodology of the WHO-certified Test of the Sensitivity of Larvae to Insectivides and Repellents. The sensitivity to insecticides and repellents of the Anopheles gambia mosquito larvae of the sensitive Kis strain and of the resistant AcerKis and KdrKis strains, was determined using the larval sensitivity test (or WHO-certified cup test). The larvae, selected at the L3/L4 stages, were placed in cups containing 100 mL of osmosis water in the presence of the substance to be tested or only the solvent in the case of controls. Four cups of 25 larvae were exposed to one modality, for a total of 100 larvae. The mortality rate was observed 24 jours and 48 hours after exposure to the insecticide. The mortality rates presented herein were corrected for the mortality observed in the controls of each replicate according to the Abbott formula (Abbott, J. Econom. Entomol., 1925, 18: 265-267).

### Results

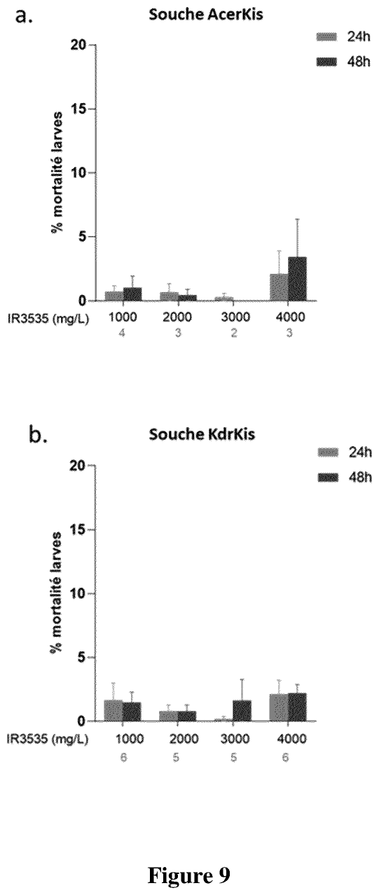

Assessment of the Sensitivity of Anopheles gambiae Larvae of Resistant Strains AcerKis and KdrKis to the Repellent IR3535 Used Alone. The larval sensitivity tests allowed to assess the percentage of mortality of mosquito larvae of the AcerKis and KdrKis strains at different concentrations of IR3535. FIG. 9 illustrates the effect of a range of IR3535 concentrations between 1000 mg/L and 4000 mg/L on mosquito larval mortality determined at 24 and 48 hours. The mortality rates induced at these concentrations are less than 5%, i.e., interesting sublethal concentrations to be considered in order to test the ternary association. In fact, IR3535, used as synergizing agent, must not cause significant mortality.

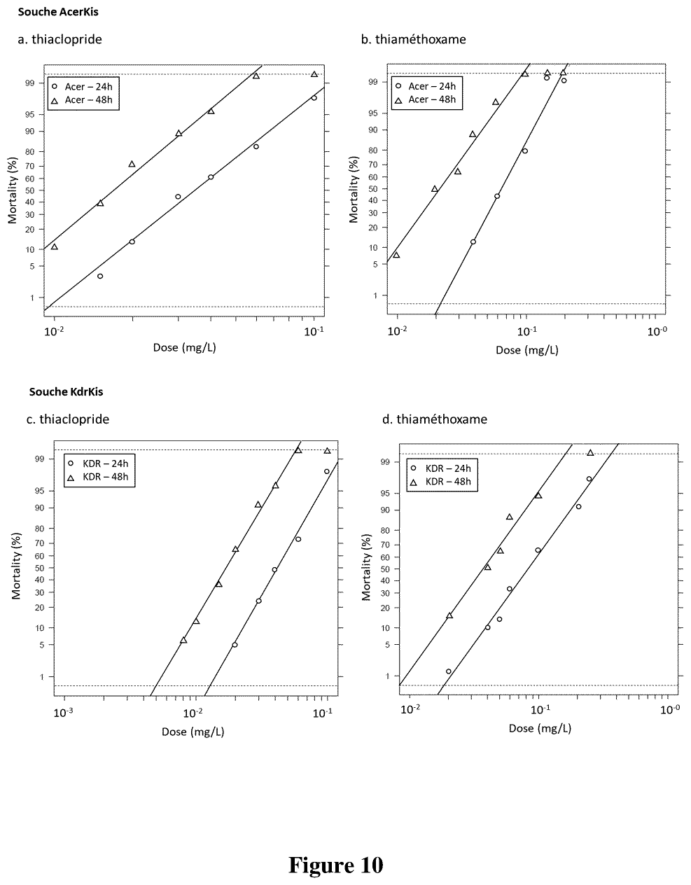

Assessment of the Sensitivity of Anopheles gambiae Larvae of Resistant Strains AcerKis and KdrKis to the two Neonicotinoid Insecticides, Thiamethoxam and Thiacloprid, Used Alone. The concentration-mortality regression curves (log-probit) presented on FIG. 10 were established by taking into account different concentrations of thiacloprid and of thiamethoxam over a range between 0.001 and 0.2 mg/L in order to frame the lethal concentrations between 10% (LC10) and 90% (LC90) at 24 and 48 jours on mosquito larvae of the two resistant strains AcerKis and KdrKis.

After establishing these curves, the present inventors estimated the concentrations producing a sublethal mortality of 10% in the larvae (LC10), following 24 hours and 48 jours of exposure to the two insecticides, for each of the two resistant strains AcerKis and KdrKis (Table 2). These LC10s were used in the various combinations tested. For the rest of the experiments, only the LC 10s will be considered since it is desired to use an optimized formulation of insecticide combinations that causes mortality but at low concentrations.

TABLE 2
Estimation of insecticide concentrations inducing 10% mortality
in larvae of resistant strains AcerKis and KdrKis. Lethal
concentrations causing 10% mortality (LC10) in larvae of
AcerKis and KdrKis strains following 24 jours and 48 hours
exposure to thiacloprid and thiamethoxan. Estimates by graphical
projection from log-probit regression curves.

| Strain | Insecticide | LC10 - 24 hours | LC10 - 48 hours |
|---|---|---|---|
| AcerKis | Thiacloprid | 0.02 mg/L | 0.01 mg/L |
| | Thiamethoxam | 0.04 mg/L | 0.01 mg/L |
| KdrKis | Thiacloprid | 0.02 mg/L | 0.01 mg/L |
| | Thiamethoxam | 0.04 mg/L | 0.02 mg/L |

### Evaluation of the Sensitivity of Anopheles gambia Larvae of Resistant Strains AcerKis and KdrKis to the Association of the Two Neonicotinoid Insecticides, Thiamethoxam and Thiacloprid

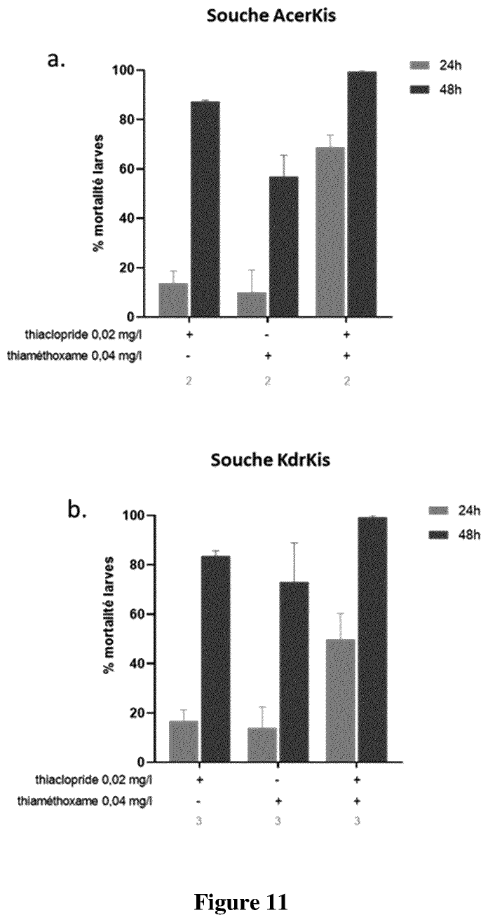

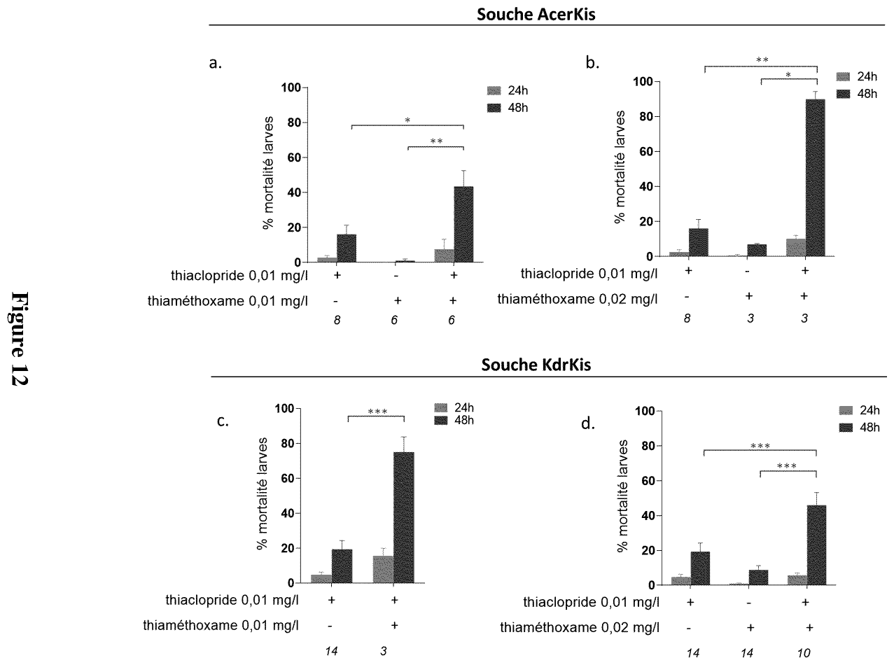

Effect of the Combination of the two Insecticides (24 hour LC10) on Larvae of the AcerKis and KdrKis strains. The larval sensitivity test was used to evaluate the effect of the binary combination thiacloprid/thiamethoxam on the resistant strains AcerKis and KdrKs. The combination: thiacloprid 0.02 mg/L and thiamethoxam 0.04 mg/L, corresponding to the LC10 after 24 hours of exposure, was found to induce a synergistic effect in the larvae of the two resistant strains AcerKis (FIG. 11a) and KdrKis (FIG. 11b). This effect was more significant 24 hours after exposure to the insecticides.

Effect of the Combination of the two Insecticides (48 hour LC10) on Larvae of the AcerKis and KdrKis strains. As shown on FIG. 12, the thiacloprid/thiamethoxam associations corresponding to the LC10 but this time determined 48 hours after exposure also induced synergistic effects in the larvae of the two resistant strains. Depending on these resistant strains, the thiacloprid concentration is 0.01 mg/L for the AcerKis and KdrKis strains while the thiamethoxam concentration is 0.01 mg/L for AcerKis and 0.02 mg/L for KdrKis. Under these conditions, for the AcerKis strain, the strongest synergy was obtained with the combination thiacloprid 0.01 mg/L and thiamethoxam 0.02 mg/L 48 hours after exposure (FIG. 12a). In this case, the binary combination was found to cause 89.93% mortality while the insecticides tested alone induced less than 20% mortality individually (FIG. 12b). In the KdrKis strain, the strongest synergy is obtained 48 hours after exposure to the combination with thiacloprid used at 0.01 mg/L and thiamethoxam also used at 0.01 mg/L (FIG. 12c). The percentage of mortality was 75.02%. For a higher concentration of thiamethoxam (0.02 mg/L), the synergistic effect measured at 48 hours was much less important (FIG. 12d).

These differences in effect are due to physiological compensation mechanisms recently demonstrated in the SIFCIR laboratory, that is inherent to the two resistant strains (Perrier et al., Communications Biology, 2021, 4: 665).

### Evaluation of the Sensitivity of Anopheles gambia Larvae of Resistant Strains AcerKis and KdrKis to the Association IR3535/Thiacloprid/Thiamethoxam

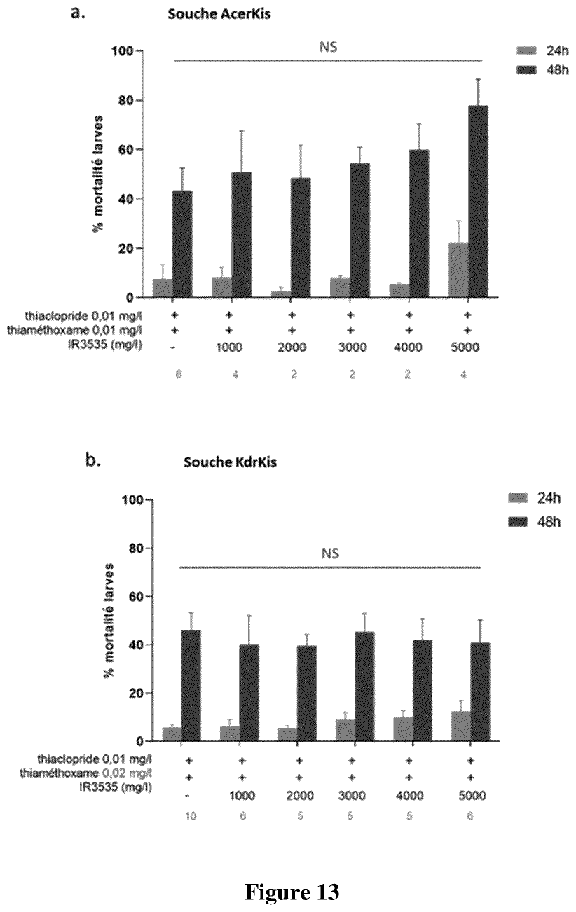

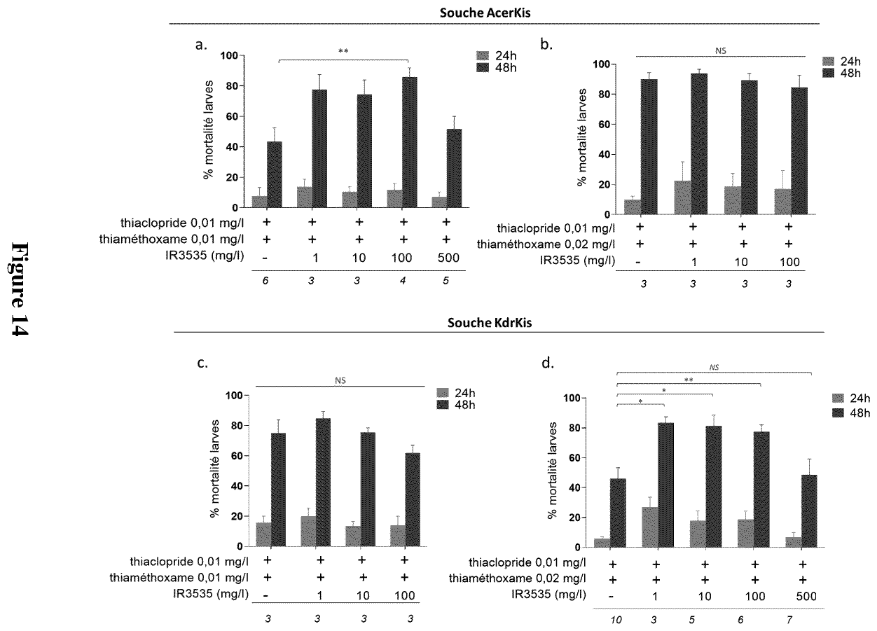

In the study of the sensitivity of the larvae to the ternary combination IR3535/thiacloprid/thiamethoxam, the inventors considered the combinations of insecticides producing a synergistic effect and a larval mortality of less than 50%, in order to be able to evaluate the effect of the addition of IR3535. They therefore tested the combinations at concentrations of thiacloprid at 0.01 mg/L, thiamethoxam at 0.01 mg/L (AcerKis) and 0.02 mg/L (KdrKis) (FIG. 13).

It was shown above, that the associations between thiacloprid at 0.02 mg/L and IR3535 in a range between 2000 and 4000 mg/L induced a synergistic effect on the mean mortality observed in larvae of the resistant strain AcerKis. The inventors proceeded from these conclusions by widening the concentration range of IR3535 to be sure to have the maximum results. The tested concentration range of IR3535 was between 1000 and 5000 mg/L. FIG. 13a,b shows that the addition of IR3535 at different concentrations does not induce a significantly greater mortality compared to the binary combination thiacloprid/thiamethoxam used without IR3535 on the resistant strains AcerKis and KdrKis. These results suggest several hypotheses based on the role of calcium in the synergistic potentiating effect. The inventors have shown that calcium is an essential element in optimizing the insecticidal effect but that this increase in calcium, which is necessary, must be controlled. In the case of too high an increase in calcium, it is either the absence of an effect or an antagonistic effect that can be observed on the insecticidal action (Moreau et al., Scientific Reports, 2020, 10(1): 1-15). However, these three compounds, IR3535, thiacloprid and thiamethoxam alone, increase intracellular calcium. From these results, it was decided to decrease the IR335 concentrations in the ternary combination to optimize the effect of the triple combination on the mortality of mosquito larvae.

A range of lower concentrations of IR3535, between 1 and 500 mg/L was therefore tested (FIG. 14). The results obtained clearly show the influence of increased calcium in the synergistic effect. From the results obtained for the AcerKis strain (FIG. 14a, b) and KdrKis (FIG. 14c, d), a significant synergistic effect of the ternary association was obtained at 48 hours with the following combinations and a maximum concentration of IR3535 of 100 mg/L:

With the AcerKis strain: IR3535 100 mg/L+thiacloprid0.01 mg/L+thiaméthoxam 0.01 mg/L; and

With the KdrKis strain: IR3535 100 mg/L +thiacloprid 0.01 mg/L+thiaméthoxam 0.02 mg/L.

### Conclusions

The objective of the study was to characterize the effect of different combinations of a ternary association IR3535/thiacloprid/thiamethoxam on the sensitivity of Anopheles gambiae mosquitoe larvae from the resistant strains, AcerKis and KdrKis, using the larval sensitivity test. The results made it possible to demonstrate the significant synergistic effects of this association for the two resistant strains with the following combinations:

For the AcerKis strain: IR3535 100 mg/L+thiacloprid 0.01 mg/L+thiaméthoxam 0.01 mg/L; and

For the KdrKis strain: IR3535 100 mg/L+thiacloprid 0.01 mg/L+thiaméthoxam 0.02 mg/L.

The inventors had shown the synergistic effect of the combination of thiacloprid at 0.02 mg/L and IR3535 but in a concentration range between 2000 and 4000 mg/L on the average mortality of mosquito larvae of resistant Anopheles gambiae strain AcerKis. The latest results show a high efficiency of the triple combination obtained at 48 hours with IR3535 concentrations 40 times lower. In the latter case, the mortality of resistant larvae is twice as high as that obtained with only the binary association (FIG. 14a, d). It now remains to be seen whether a reduction in the concentration of each insecticide is possible to further optimize the effectiveness of the treatment.

### Other Embodiments

Other embodiments of the invention will be apparent to those skilled in the art from a consideration of the specification or practice of the invention disclosed herein. It is intended that the specification and examples be considered as exemplary only, with the true scope of the invention being indicated by the following claims.

1-19. (canceled)

20. A mosquito insecticide comprising a binary synergistic combination consisting of thiacloprid and thiamethoxam or comprising a ternary synergistic combination consisting of thiacloprid, thiamethoxam and IR3535.

21. The mosquito insecticide according to claim 20, wherein the mosquito insecticide is a mosquito adulticide.

22. The mosquito insecticide according to claim 20, wherein the mosquito insecticide is a mosquito larvicide.

23. The mosquito insecticide according to claim 20, wherein in the synergistic binary mixture of thiacloprid and thiamethoxam, the molar ratio between thiacloprid and thiamethoxam is comprised between about 0.01:1 and about 1:0.01.

24. The mosquito insecticide according to claim 20, wherein in the synergistic binary mixture of thiacloprid and thiamethoxam, the molar ratio between thiacloprid and thiamethoxam is comprised between about 0.1:1 and about 1:0.1.

25. The mosquito insecticide according to claim 20, wherein in the synergistic ternary mixture of thiacloprid, thiamethoxam and IR3535, the molar ratio between IR3535 and the mixture of thiacloprid and thiamethoxam is comprised between about 0.005:1 and about 0.1:1.

26. The mosquito insecticide according to claim 20, wherein in the synergistic ternary mixture of thiacloprid, thiamethoxam and IR3535, the molar ratio between IR3535 and the mixture of thiacloprid and thiamethoxam is comprised between about 0.01:1 and about 0.1:1.

27. The mosquito insecticide according to claim 26, wherein in the synergistic ternary mixture of thiacloprid, thiamethoxam and IR3535, the molar ratio between thiacloprid and thiamethoxam is comprised between about 0.01:1 and about 1:0.01.

28. The mosquito insecticide according to claim 26, wherein in the synergistic ternary mixture of thiacloprid, thiamethoxam and IR3535, the molar ratio between thiacloprid and thiamethoxam is comprised between about 0.1:1 and about 1:0.1.

29. The mosquito insecticide according to claim 20, wherein in the mosquito insecticide comprising a binary synergistic combination of thiacloprid and thiamethoxam, the concentration of each of thiacloprid and thiamethoxam is comprised between about 10⁻⁹ M and about 10⁻⁵ M.

30. The mosquito insecticide according to claim 29, wherein in the mosquito insecticide comprising a binary synergistic combination of thiacloprid and thiamethoxam, the concentration of each of thiacloprid and thiamethoxam is comprised between about 5·10⁻⁸ M and about 5·10⁻⁶ M.

31. The mosquito insecticide according to claim 20, wherein in the mosquito insecticide comprising an in vitro ternary synergistic mixture of thiacloprid, thiamethoxam and IR3535, the concentration of IR3535 is comprised between about 5·10⁻¹² M and about 5·10⁻⁹ M and the concentration of each of thiacloprid and thiamethoxam is comprised between about 10⁻⁹ M and about 10⁻⁵ M.

32. The mosquito insecticide according to claim 31, wherein in the mosquito insecticide comprising an in vitro ternary synergistic mixture of thiacloprid, thiamethoxam and IR3535, the concentration of IR3535 is comprised between about 10⁻¹¹ M and about 5·10⁻¹⁰ M and the concentration of each of thiacloprid and thiamethoxam is comprised between about 5·10⁻⁸ M and about 5·10⁻⁶ M.

33. The mosquito insecticide according to claim 20, wherein in the mosquito insecticide comprising an in vivo ternary synergistic mixture of thiacloprid, thiamethoxam and IR3535, the concentration of IR3535 is 100 mg/L (4.6·10⁻⁴M), the concentration of thiacloprid is 0.01 mg/L (4·10⁻⁸M) or less, and the concentration of thiamethoxam is 0.02 mg/L (6.9·10⁻⁸M) or 0.01 mg/L (3.4·10⁻⁸M) or less.

34. The mosquito insecticide according to claim 20, further comprising at least one additional biologically active agent.

35. A method for preventing or inhibiting infestation of mosquitoes comprising a step of using a mosquito insecticide according to claim 20.

36. The method according to claim 35, wherein the mosquitoes are insecticide resistant.

37. The method according to claim 36, wherein the mosquitoes are resistant to at least one insecticide selected from the group consisting of organophosphate insecticides, carbamate insecticides, and pyrethroid insecticides.

38. A method to control mosquito-borne diseases, the method comprising a step of using a mosquito insecticide according to claim 20, wherein the mosquito-borne diseases are transmitted by mosquitoes infected by a pathogen selected from the group consisting of viruses, nematodes, protozoa, and bacteria.

39. The method according to claim 38, wherein the mosquito-borne diseases are transmitted to mammal hosts.

40. The method according to claim 39, wherein the mammal hosts are human beings.

41. The method according to claim 40, wherein the mosquito-borne diseases are selected from the group consisting of Zika virus infection, Dengue fever infection, Yellow fever, Chikungunya, West Nile virus infection, St. Louis Encephalitis, Dengue and malaria.

42. The method according to claim 38, wherein the mosquitoes belong to a genus selected from the group consisting of the Aedes, Anopheles, Culex, Culiseta and Mansonia genuses.

43. The method according to claim 38, wherein the mosquitoes belong to a species selected from the group consisting of Aedes aegypti, Aedes albopictus, Aedes australis, Aedes cantator, Aedes cinereus, Aedes polynesiensis, Aedes rusticus, Aedes taeniorhynchus, Aedes vexans, Anopheles species: Anopheles albimanus, Anopheles arabiensis, Anopheles atroparvus, Anopheles baimaii, Anopheles balabacensis, Anopheles barberi, Anopheles bellator, Anopheles cruzii, Anopheles culicifacies, Anopheles darlingi, Anopheles dirus, Anopheles earlei, Anopheles farauti, Anopheles freeborni, Anopheles funestus, Anopheles gambiae, Anopheles introlatus, Anopheles latens, Anopheles leucosphyrus, Anopheles maculatus, Anopheles minimus, Anopheles moucheti, Anopheles nili, Anopheles punctipennis, Anopheles punctulatus, Anopheles pseudopunctipennis, Anopheles quadrimaculatus, Anopheles sergentii, Anopheles sinensis, Anopheles stephensi, Anopheles subpictus, Anopheles sundaicus, Anopheles walkeri, Culex annulirostris, Culex antennatus, Culex jenseni, Culex pipiens, Culex pusillus, Culex quinquefasciatus, Culex rajah, Culex restuans, Culex salinarius, Culex tarsalis, Culex territans, Culex theileri, Culex tritaeniorhynchus, Culiseta incidens, Culiseta impatiens, Culiseta inornata, Culiseta particeps, Mansonia annulifera, Mansonia bonneae, Mansonia dives, Mansonia indiana, Mansonia uniformis.

44. The method according to claim 38, wherein the mosquitoes belong to a species selected from the group consisting of Aedes aegypti, Aedes albopictus, Culex quinquefasciatus, Culex pipiens, Culex tarsalis.
